(19) United States
(12) Patent Application Publication
(10) Pub. No.: US 2026/0330256 A1
(43) Pub. Date: Oct. 22, 2026

(54) SYSTEM

(71) Applicant: SoftBank Group Corp., Tokyo (JP)

(72) Inventor: Hiroshi YAMAZAKI, Tokyo (JP)

(73) Assignee: SoftBank Group Corp., Tokyo (JP)

(21) Appl. No.: 19/647,943

(22) Filed: Apr. 15, 2026

(30) Foreign Application Priority Data
Apr. 22, 2025 (JP) 2025-070265

(51) Int. Cl. G06N 5/022; G06F 16/22; G06F 16/2458; G06F 18/21; G06N 3/0475

(52) U.S. Cl. CPC G06N 5/022; G06F 16/2237; G06F 16/2458; G06F 18/2178; G06N 3/0475

(57) ABSTRACT

The present invention relates to a system that provides an AI agent optimized for each industry and business on a rental basis via a network using generative AI as an essential component, allocates the agent in accordance with a business content and attribute information of a user, automatically processes a business task while referring to a knowledge base and past data, and sequentially learns and accumulates feedback from the user and new business data, thereby realizing business efficiency improvement, elimination of wasteful business, and innovation of business processes. Furthermore, the system supports storage and continuous utilization of learning data and incorporation into various devices, and contributes to elimination of human resource shortages and productivity improvement of the whole society.

### CROSS-REFERENCE TO RELATED APPLICATION

The present application claims priority to and incorporates by reference the entire contents of Japanese Patent Application No. 2025-070265 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to flexibly and promptly respond to diverse and complex business needs that cannot be fully addressed by conventional temporary staffing or outsourcing, with respect to management issues such as human resource shortages and increases in human resource costs that are becoming serious in all societies, all fields, all industries, and all occupations other than physical business in Japan, as well as sales stagnation and sluggishness, and delays in business organization and business transformation in current business, to realize business efficiency improvement, elimination of wasteful business, and innovation of business processes for a user by providing an AI agent optimized for each industry and business via a network using generative AI, and further, to adapt to user-specific know-how and business flows by the AI agent continuously learning and accumulating business experiences at a usage destination, thereby bringing about new business methods and business transformation that could not be conceived by humans in the past, and simultaneously achieving productivity improvement and cost reduction of the whole society.

### SUMMARY OF THE INVENTION

A means for solving the problem according to the present invention comprises: an agent allocation unit having a knowledge base pre-trained for each industry and business, and configured to allocate an optimal AI agent in accordance with a business content designation from a user; a task processing unit configured such that the allocated AI agent receives a business task on a terminal or device of the user via a network, analyzes and processes the task using generative AI, and outputs a processing result; a learning accumulation unit configured to sequentially learn new business data and user-specific business know-how obtained while the AI agent performs the business, and reflect the learned data and know-how in the knowledge base of the agent; and a data storage unit configured to store learning data even after a business period ends in accordance with a selection by the user, and make the learning data continuously utilizable during subsequent uses, wherein the agent allocation unit, the task processing unit, the learning accumulation unit, and the data storage unit cooperate, using the generative AI as an essential component, to realize elimination of human resource shortages, business efficiency improvement, and business transformation in all societies, all fields, all industries, and all occupations other than physical business.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### FIRST EMBODIMENT

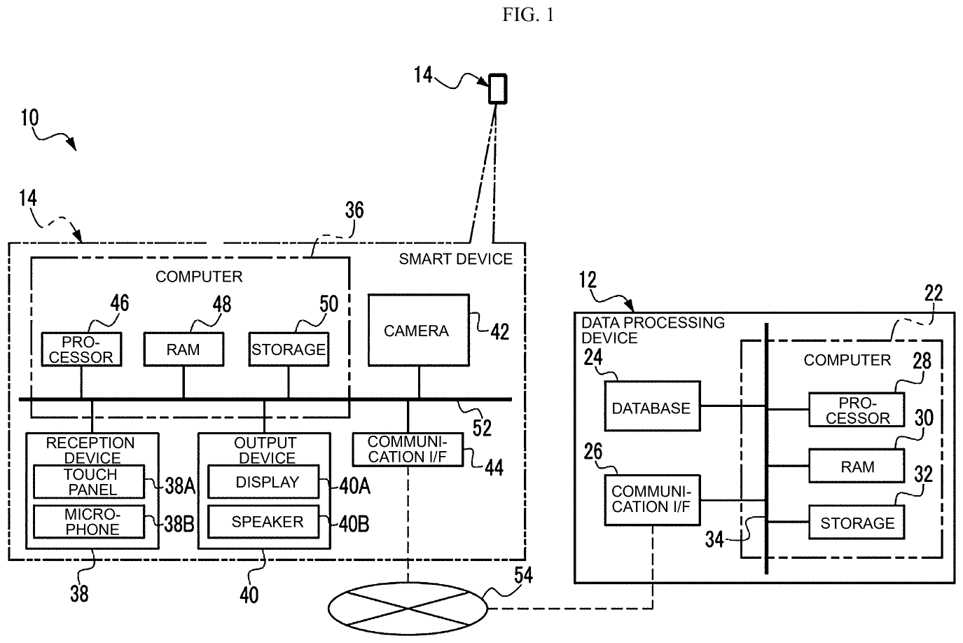

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

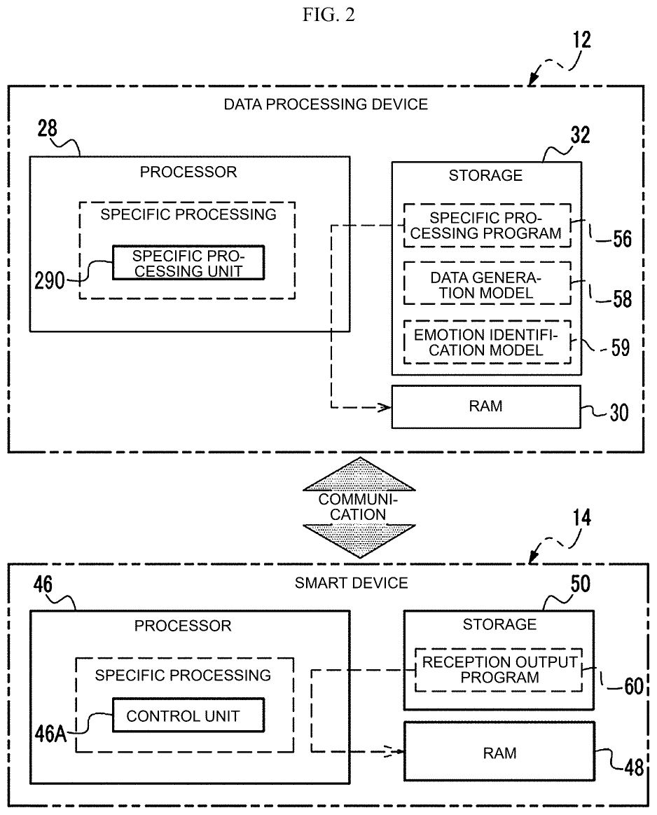

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

As an embodiment for carrying out the present invention, a specific configuration and an operation example of a cloud-type AI agent service in which a server and a terminal are linked will be described in detail.

First, a server side includes a database configured to store a knowledge base pre-trained for each industry and business, an agent allocation unit configured to receive a business content designation and attribute information (industry, job type, business content, user skill level, past usage history, and the like) from a user and select and allocate an optimal AI agent, a learning accumulation unit configured to sequentially learn new business data, user-specific business know-how, a business flow, an irregular response case in business, and the like obtained while the AI agent performs the business, and reflect the learned data and the like in the knowledge base, a data storage unit configured to store learning data even after a business period ends in accordance with a selection by the user, and make the learning data continuously utilizable during subsequent uses, and a management unit configured to supervise all of these. A large-scale model of generative AI (for example, a natural language processing model, an image generation model, a voice recognition/synthesis model, a structured data analysis model, and the like) is implemented in the server, and these function as a core of each AI agent. Specifically, the server system includes a parallel computing cluster composed of a plurality of computing nodes. The database functions as a distributed vector database that stores high-dimensional vector data. The agent allocation unit converts the input attribute information into a multidimensional embedding vector using the natural language processing model. The agent allocation unit receives a text character string including the attribute information of the user as input data. The agent allocation unit removes stop words from the text character string and performs tokenization as preprocessing. The agent allocation unit converts the tokenized data into a 512-dimensional numerical vector. Specific examples of the input data include text data indicating that the industry is manufacturing and the job type is design, numerical data indicating that a drawing generation task has been executed ten times as a past usage history, categorical data indicating a current skill level, and the like. The agent allocation unit calculates a cosine similarity between the embedding vector and a characteristic vector of each AI agent. The agent allocation unit dynamically selects an AI agent having the maximum similarity score. The agent allocation unit outputs an array of probability scores in a range of 0 to 1 indicating a fitness of each AI agent as output data. Specific examples of the output data include a numerical group such that a score for a design support agent is 0.95, a score for an office work support agent is 0.12, and a score for a translation agent is 0.05. The agent allocation unit deploys an instance of the agent with the highest score on a memory and allocates a task as subsequent processing. The learning accumulation unit divides the collected new business data into a predetermined token length. The learning accumulation unit formats the divided data as input data for self-supervised learning. The learning accumulation unit fine-tunes weight parameters of the large-scale model using a backpropagation method. The data storage unit securely writes the learning data to a storage using an encryption algorithm. The management unit constantly monitors CPU and memory usage rates of each module. The management unit automatically increases or decreases the number of instances of containerized AI agents in accordance with a load status. The large-scale model implemented in the server adopts a transformer architecture. The natural language processing model converts the input text into a one-dimensional array of token IDs. The natural language processing model extracts a dependency relationship between tokens by matrix calculation using a self-attention mechanism. The image generation model adopts a latent diffusion model. The image generation model removes noise stepwise from a random noise tensor. The image generation model finally outputs a high-resolution image tensor. The voice recognition model converts the input voice waveform into a two-dimensional tensor of Mel-frequency cepstral coefficients. The voice recognition model outputs a probability distribution of phonemes using a convolutional neural network. The structured data analysis model converts tabular data into a graph structure. The structured data analysis model learns a relationship between nodes using a graph neural network. The system dramatically improves a processing speed by cooperation of these specific hardware and algorithms. The system eliminates a bottleneck of agent allocation and data management by conventional manual work. The system brings about technical effects of optimizing calculation resources and improving inference accuracy. The system exhibits extremely high usefulness in specific application fields such as complete automation of large-scale call center business and company-wide back-office business. The system processes a task using an unconventional method peculiar to a computer, which is vector calculation in a high-dimensional space, rather than simply imitating a human mental process. The system thereby realizes flexible and highly accurate information processing exceeding specific rule-based processing.

A terminal side includes a user interface (text input, voice input, image input, file upload, selective UI, and the like) for the user to input and designate a business task, a display unit configured to communicate with the server and receive and display a business processing result by the AI agent, a local processing unit configured to execute a part of task processing and data preprocessing (for example, image resizing and noise removal, voice data format conversion, simple OCR processing, and the like) on the terminal as necessary, a notification/remind function according to a business content and a user attribute, and a security function (authentication/authorization, data encryption, terminal lock, and the like). Specifically, the terminal system constructs an edge computing environment. The local processing unit includes a dedicated processor for accelerating inference of a neural network. The local processing unit receives an RGB image tensor acquired from a camera of the terminal as input data. The local processing unit resizes a resolution of the image tensor to 224 by 224 pixels and normalizes pixel values as preprocessing. Specific examples of the input data include an image tensor obtained by photographing a receipt, an image tensor obtained by photographing a handwritten memo, an image tensor obtained by photographing a whiteboard of a meeting, and the like. The local processing unit extracts a feature map in the image using a convolutional neural network. The local processing unit outputs a clean image tensor in which a noise component in the image is reduced and bounding box coordinates of an extracted text region as output data. Specific examples of the output data include a high-contrast image tensor after noise removal, an array of four vertex coordinates indicating the text region, angle data indicating an inclination of characters, and the like. The local processing unit encrypts these output data and transmits the encrypted output data to the server via a communication unit as subsequent processing. The local processing unit samples a voice waveform and converts the voice waveform into a digital signal for voice input. The local processing unit applies a fast Fourier transform to the digital signal to extract a frequency spectrum. The local processing unit significantly reduces a communication band by transmitting the frequency spectrum to the server. The security function protects an encryption key at a hardware level using a secure enclave technology. The security function calculates a Euclidean distance between a feature vector obtained from a biometric authentication sensor and a registered template vector. The security function unlocks the terminal only when the distance is equal to or less than a predetermined threshold. The system reduces a data transmission amount to the server and reduces a latency of the entire system by these local processings. The system distributes a calculation load on the server side by data preprocessing on an edge side. The system thereby brings about technical effects of a highly real-time response and enhancement of privacy protection. The system exhibits extremely high usefulness in specific application fields such as a mobile terminal handling highly confidential medical data and a fieldwork device in an offline environment. The system maximizes processing efficiency using an advanced computer technology of cooperative inference between an edge and a cloud, rather than simple data transmission and reception.

Specific operation examples will be given in further detail.

For example, when a user in general office work inputs various business tasks such as “creation of an invoice”, “automatic generation of meeting materials”, “check of an expense settlement form”, “automatic creation of a schedule adjustment email”, “automatic summarization of minutes”, “updating of a customer list”, and “drafting of a contract” from the terminal, the terminal transmits these task information to the server. The agent allocation unit of the server comprehensively determines the industry and business content of the user, the past usage history, a current business load status, and the like, and allocates an optimal AI agent. For example, for an invoice creation task, the generative AI refers to a format of the user's company, past invoice data, business partner information, a consumption tax rate, a closing date, and the like, automatically extracts and inputs necessary items, automatically adjusts an appearance and wording, and generates an invoice. In the automatic generation of meeting materials, the generative AI automatically collects and summarizes an agenda of a meeting, participants, past minutes, related industry news, statistical data, and the like, and generates materials including graphs and charts. In the check of an expense settlement form, the generative AI performs OCR analysis of a receipt image, matching with expense regulations, abnormal value detection, automation of an approval flow, and the like. In the automatic creation of a schedule adjustment email, the generative AI refers to calendar information of related parties, automatically extracts optimal candidate dates, and automatically generates an email with polite wording. Specifically, the generative AI receives a combined tensor of structured data and unstructured data related to the invoice creation task as input data. The generative AI complements missing values from the past invoice data and divides text data into subwords as preprocessing. Specific examples of the input data include text data in a JSON format including a business partner name and an amount, a time-series numerical array indicating a past transaction history, a pixel tensor of a company logo image, and the like. The generative AI maps these input data to a vector in a latent space using a transformer-based encoder-decoder model. The generative AI calculates a dependency relationship between each data item using a self-attention mechanism. The generative AI outputs structured data including layout information of the generated invoice and a text character string of each item as output data. Specific examples of the output data include tree structure data of a document object model convertible to a PDF format, a floating-point numerical value of an extracted consumption tax amount, a text character string of a generated greeting, and the like. The generative AI transmits the output data to the display unit to prompt the user for confirmation, and automatically performs API linkage to an approval flow system as subsequent processing. In the expense settlement form check task, the generative AI receives a receipt image as an input tensor. The generative AI extracts a character region from the image using a convolutional neural network. The generative AI inputs the extracted character region to a recurrent neural network and recognizes a character string. The generative AI collates the recognized character string with a database of expense regulations and calculates an abnormality score. The generative AI sets a warning flag when the abnormality score exceeds a threshold. In the schedule adjustment task, the generative AI reads calendar data of a plurality of related parties as a multidimensional array. The generative AI searches for an optimal time slot in which free times of all members overlap using an algorithm of a constraint satisfaction problem. The system dramatically shortens a time for conventional manual data input and confirmation work by these advanced algorithms. The system brings about technical effects of eliminating human errors and improving accuracy of business. The system exhibits extremely high usefulness in specific application fields such as an accounting department where a large amount of document processing occurs and a sales department where frequent schedule adjustment is required. The system automates business using an unconventional method peculiar to a computer, which is vector calculation in a high-dimensional space and an optimization algorithm, rather than imitating a human cognitive process.

As a specific example in an educational field, for example, when a school teacher requests “analysis of a grade transition for each student and creation of an individual guidance plan”, “automatic generation of teaching materials for a class”, “automatic creation and scoring of a quiz”, “automatic creation of a notification text for parents”, “summarization of a student career consultation record”, “automatic editing of a class video”, and the like, the generative AI analyzes grade data, attendance information, a past guidance record, a learning achievement level, curriculum guidelines, a latest educational trend, an external teaching material database, and the like, and automatically generates an individual guidance plan, teaching materials, test questions, a notification text, a career guidance report, and the like. For example, in the summarization of a student career consultation record, the generative AI comprehensively analyzes a past interview record, information on a student's school of choice, an aptitude test result, and the like, and creates an easy-to-understand summary report for parents and students. In the automatic editing of a class video, the generative AI automatically extracts an important part from recorded data, cuts an unnecessary part, and automatically inserts subtitles and illustrations. Specifically, the generative AI receives a time-series array indicating a student's grade transition and a text vector of a past guidance record as input data. The generative AI calculates a moving average of time-series data and performs dimensionality reduction of the text vector as preprocessing. Specific examples of the input data include a one-dimensional numerical array including math test scores for the past five times, binary data indicating a student's attendance status, a natural language text including a teacher's comments, and the like. The generative AI updates a hidden state vector of the time-series data using a long short-term memory network. The generative AI inputs the hidden state vector to a fully connected layer and calculates a future grade prediction score. The generative AI outputs a multidimensional probability distribution indicating a student's understanding level and a text token sequence of an individual guidance plan as output data. Specific examples of the output data include a score of 0.2 indicating that an understanding level in an algebra field is low, an identifier list of recommended learning materials, a generated text of a notification text for parents, and the like. The generative AI inputs these output data to a PDF generation module and renders the output data as a printable report as subsequent processing. In the automatic editing task of a class video, the generative AI receives recorded video data as a three-dimensional tensor. The generative AI extracts spatial and temporal feature amounts from each frame of the video using a three-dimensional convolutional neural network. The generative AI integrates text data extracted from an audio track and the feature amounts of the video using a multimodal attention mechanism. The generative AI automatically deletes a frame section in which an importance score falls below a predetermined threshold. The generative AI generates a subtitle text based on a voice recognition result and superimposes the subtitle text on a video frame. The system significantly reduces a burden of office work on a teacher by these processings. The system brings about a technical effect of providing personalized education based on data-driven objective analysis. The system exhibits extremely high usefulness in specific application fields such as a large-scale online learning platform and a private tutoring school. The system processes educational data using an unconventional method peculiar to a computer, which is time-series analysis and multimodal learning, without depending on human subjective evaluation.

As a specific example for an engineer, for example, when a designer requests “creation of a specification document for a new product”, “review of a design drawing”, “automatic generation of a bill of materials”, “summarization of technical literature”, “management of a design change history”, “automatic creation of a development progress report”, and the like, the generative AI analyzes CAD data, a past specification document, a parts database, a technical paper, a design change history, a development schedule, and the like, and automatically generates a specification document, a drawing review comment, a bill of materials, a summary report, a progress management table, and the like. When a programmer requests “code review”, “bug detection”, “automatic generation of a test case”, “automatic creation of a document”, “automatic generation of an API specification document”, and the like, the generative AI analyzes a source code, points out a bug or an inefficient description, and automatically generates a correction proposal, a test case, and a document. Specifically, the generative AI receives a vertex coordinate tensor of three-dimensional CAD data and a text vector of a design change history as input data. The generative AI converts a three-dimensional model into a voxel grid and constructs a graph structure as preprocessing. Specific examples of the input data include polygon mesh data indicating a shape of a part, a numerical vector indicating physical characteristics of a material, text data of a past defect report, and the like. The generative AI learns a spatial relationship between nodes using a graph neural network. The generative AI compares a distribution of normal patterns extracted from past design data with the input data. The generative AI outputs a heat map of an abnormality score indicating a vulnerability of a design and a text character string of an improvement proposal as output data. Specific examples of the output data include a pair of three-dimensional coordinates indicating a stress concentration location and a high abnormality score of 0.88, a model number list of alternative parts, abstract syntax tree data of a corrected source code, and the like. The generative AI issues a control command to highlight a location where the abnormality score exceeds a predetermined threshold in red on a CAD viewer as subsequent processing. In the code review task, the generative AI parses text data of a source code into an abstract syntax tree. The generative AI inputs the abstract syntax tree to a tree-structured neural network and vectorizes a logical structure of the code. The generative AI collates with a vector database of known vulnerability patterns and calculates a similarity. The generative AI specifies a location having a high risk of a memory leak or a buffer overflow. The generative AI generates a code snippet of a correction proposal and automatically transmits the code snippet to a version control system as a pull request. The system discovers a design mistake or a software bug at an early stage by these advanced analyses. The system brings about technical effects of shortening a development cycle and improving product quality. The system exhibits extremely high usefulness in specific application fields such as a manufacturing industry performing complex machine design and a large-scale software development project. The system processes technical data using an unconventional method peculiar to a computer, which is graph structure analysis and vectorization of an abstract syntax tree, rather than simply automating a visual check by a human.

As a specific example in a nursing care and welfare field, when a welfare worker requests “creation of a care plan for each user”, “abnormality detection of vital data”, “automatic summarization of a nursing care record”, “automatic creation of a report for a family member”, “a companion for a caregiver”, “proposal of a recreation plan”, and the like, the generative AI analyzes a health condition, a past care record, medical data, a life pattern, a family structure, hobbies and preferences, and the like of a user, and automatically generates an optimal care plan, report, recreation plan, and dialogue content. For example, in the abnormality detection of vital data, data is collected in real time from a sensor on the terminal side, and the generative AI on the server side detects an abnormal pattern and immediately outputs an alert or a response plan. Specifically, the generative AI receives a time-series tensor of vital data acquired from the sensor on the terminal side as input data. The generative AI removes high-frequency noise of sensor data with a low-pass filter and performs normalization as preprocessing. Specific examples of the input data include a one-dimensional array of a heart rate measured at one-minute intervals, time-series data of a body surface temperature, a three-axis motion vector obtained from an acceleration sensor, and the like. The generative AI extracts a local feature pattern from the time-series data using a one-dimensional convolutional neural network. The generative AI calculates a reconstruction error of normal vital data using an autoencoder architecture. The generative AI determines an abnormality when the reconstruction error exceeds a statistical threshold. The generative AI outputs a probability score indicating an abnormality in the health condition of the user and structured data of a recommended care plan as output data. Specific examples of the output data include a probability score of 0.92 indicating a possibility of arrhythmia, a categorical label indicating a fall risk, a text character string constituting a report to a family member, and the like. The generative AI immediately transmits an alert signal to a nurse call system when the probability score exceeds the threshold as subsequent processing. In the care plan creation task, the generative AI inputs a past care record of the user to a natural language processing model and extracts a semantic vector. The generative AI collates the semantic vector with a knowledge graph of medical guidelines. The generative AI generates a sequence of intervention actions most suitable for a current state of the user. The system prevents a serious accident at a nursing care site by these real-time analyses. The system brings about technical effects of reducing a burden of recording business on a nursing care staff member and improving quality of care. The system exhibits extremely high usefulness in specific application fields such as a facility for the elderly and a home nursing care monitoring system. The system processes nursing care data using an unconventional method peculiar to a computer, which is calculation of a reconstruction error of a time-series tensor and search of a knowledge graph, rather than depending on a human rule of thumb.

When the present system is incorporated into devices such as home appliances, mobile phones, in-vehicle devices, and nursing care devices, the AI agent incorporated on the terminal side collects a life pattern, a usage status, and sensor data (temperature, humidity, illuminance, position information, acceleration, voice, image, and the like) of the user in real time, and cooperates with the generative AI on the server side to realize, for example, “automatic generation of an optimal operation schedule for an air conditioner”, “inventory management of a refrigerator and automatic generation of a shopping list”, “schedule management and remind on a smartphone”, “optimal route proposal and driving advice by an in-vehicle device”, “monitoring and calling out by a nursing care robot”, “health management advice”, “automatic reporting in an emergency”, and the like. The generative AI analyzes various data collected from these devices and provides a personalized service for each user. For example, in the inventory management of a refrigerator, the generative AI recognizes an inventory status of food ingredients from a camera image or a weight sensor, and automatically generates a shopping list in consideration of an expiration date and a usage frequency. In an in-vehicle device, the generative AI comprehensively analyzes a past driving tendency of a driver, a current traffic status, weather, and destination information, and proposes an optimal route and a break timing. Specifically, the generative AI receives a multimodal combined tensor collected from a plurality of sensors as input data. The generative AI synchronizes sensor data having different sampling rates on a time axis and linearly interpolates missing values as preprocessing. Specific examples of the input data include an RGB image tensor acquired from an internal camera of a refrigerator, numerical data indicating a remaining amount of food ingredients obtained from a weight sensor, a time-series array of latitude and longitude obtained from a GPS of an in-vehicle device, and the like. The generative AI projects an image feature amount and numerical data into the same latent space using a multimodal transformer and learns a mutual relationship. The generative AI learns a policy for maximizing a reward based on user feedback using a reinforcement learning algorithm. The generative AI outputs a command vector for controlling a device and a text for presentation to the user as output data. Specific examples of the output data include a control signal vector for lowering a set temperature of an air conditioner by two degrees, text data of a shopping list prompting purchase of missing food ingredients, a coordinate array of a detour route for avoiding traffic congestion, and the like. The generative AI transmits the control command vector to an actuator control unit of each device to execute a physical operation as subsequent processing. In the optimal route proposal task of an in-vehicle device, the generative AI receives real-time traffic information and graph data of a past driving history as inputs. The generative AI calculates a route that optimizes a trade-off between an arrival time and fuel consumption using a heuristic search algorithm extending Dijkstra's algorithm. The system realizes autonomous control of a device by these cooperative processings of an edge and a cloud. The system brings about technical effects of improving energy efficiency and maximizing user convenience. The system exhibits extremely high usefulness in specific application fields such as construction of a smart home environment and an automatic driving support system. The system controls a device using an unconventional method peculiar to a computer, which is integration of a multimodal tensor and reinforcement learning, rather than simple control by conditional branching.

As for role sharing between the server and the terminal, high-load processing such as allocation of an AI agent, management of a knowledge base, learning accumulation, and large-scale data analysis, document generation, information summarization, natural language processing, image analysis, voice recognition, and structured data analysis by the generative AI is mainly executed on the server side. On the other hand, the terminal side is responsible for a user interface, input/output of a business task, communication with the server, local simple processing and data preprocessing as necessary, device-specific control (home appliance control, in-vehicle device control, nursing care device control, and the like), collection and primary processing of sensor data, notification/remind to the user, security management, and the like. For example, in a smartphone or a tablet terminal, the user inputs a business instruction by voice or text, and immediately receives and displays a result processed by the generative AI on the server side. In a home appliance or an in-vehicle device, sensor data is collected on the terminal side, the generative AI analyzes and optimizes the sensor data on the server side, and a control command thereof is returned to the terminal. Specifically, the generative AI on the server side receives a compressed feature vector transmitted from the terminal as input data. The generative AI on the server side performs decoding processing for restoring the compressed feature vector to an original dimensional space as preprocessing. Specific examples of the input data include a two-dimensional tensor of Mel-frequency cepstral coefficients extracted on the terminal side for voice recognition, a vector of an edge feature amount extracted from an image, an embedding vector of a natural language, and the like. The generative AI on the server side processes these feature vectors using a huge neural network having hundreds of billions of parameters. The generative AI on the server side outputs a multidimensional tensor indicating a high-load analysis result as output data. Specific examples of the output data include a text token sequence indicating a summarization result of a long sentence, a pair of bounding box coordinates and a class label indicating an object recognition result in an image, a label array indicating a clustering result of complex structured data, and the like. The generative AI on the server side returns these output data to the terminal side using an asynchronous communication protocol and causes the display unit to render the output data as subsequent processing. The terminal side functions as a client of federated learning. The terminal side updates weights of a lightweight model using locally collected data. The terminal side transmits only a difference vector of the updated weights to the server. The server side aggregates difference vectors received from a plurality of terminals and updates a global model. The system minimizes consumption of a network band by this role sharing. The system brings about a technical effect of improving accuracy of a model while protecting privacy by not transmitting raw data to the server. The system exhibits extremely high usefulness in specific application fields such as use under a mobile network with an unstable communication environment and an enterprise system handling confidential data. The system optimizes the entire system using an unconventional method peculiar to a computer, which is data compression in a feature space and distributed machine learning, rather than a simple client-server model.

The AI agent sequentially transmits new business data, user-specific know-how, a business flow, an irregular response case, user feedback, and the like obtained while performing the business to the learning accumulation unit on the server side, and the generative AI continuously learns these data, thereby flexibly adapting to the business flow and unique business knowledge for each user. For example, when a certain user uses a unique business procedure or a special format, the AI agent learns the pattern and automatically performs the business in accordance with the procedure or the format from next time onward. When the user selects to store the learning data after the business period ends, the data storage unit on the server side safely manages the learning data, and can restart the AI agent in a state where the past learning data is taken over during subsequent uses. The stored data is hierarchically managed for each user, each industry, and each business, and sufficient consideration is given to information leakage countermeasures and privacy protection. Specifically, the learning accumulation unit receives a tensor of log data including a business performance history of the AI agent and feedback from the user as input data. The learning accumulation unit masks personally identifiable information from the log data and divides the log data into batch data for learning as preprocessing. Specific examples of the input data include difference text data of an invoice corrected by the user, state transition graph data indicating a change in the business flow, numerical data of a five-level evaluation for a generation result, and the like. The learning accumulation unit sequentially updates parameters of a model using an online learning algorithm. The learning accumulation unit outputs a gradient vector for updating a weight parameter of a large-scale model as output data. Specific examples of the output data include an array of partial differential values for the weight of each neuron, a tensor of a parameter update amount multiplied by a learning rate, a scalar value that is a calculation result of a loss function, and the like. The learning accumulation unit drives an optimizer using the gradient vector to fine-tune the weight of the model as subsequent processing. The data storage unit stores a difference of the learned parameters in a format of a low-rank matrix. The data storage unit associates this low-rank matrix with an access control list and stores the low-rank matrix in a distributed file system. The data storage unit instantaneously restores a user-specific model by adding this low-rank matrix to a weight matrix of a base model at the time of next startup. The system prevents obsolescence of the model by these continuous learning mechanisms. The system brings about a technical effect of realizing personalization for each user while suppressing calculation resources. The system exhibits extremely high usefulness in specific application fields such as long-term project management and content generation tailored to individual preferences. The system accumulates knowledge using a non-conventional method peculiar to a computer, which is weight updating by a gradient descent method and addition of a low-rank matrix, instead of simply storing data in a database.

In addition, when a plurality of AI agents are in charge of a plurality of businesses concurrently, the management unit on the server side monitors an operation status and a load status of each agent, and dynamically performs optimal resource allocation and agent reallocation. For example, it is also possible to allocate a plurality of AI agents simultaneously to perform distributed processing of the business during a busy period, and reduce the number of agents to achieve cost optimization during a slow period. Specifically, the management unit receives a time-series metrics array indicating a CPU usage rate and a memory consumption amount of each AI agent as input data. The management unit removes an outlier of the metrics data and performs smoothing as preprocessing. Specific examples of the input data include numerical data indicating an average response time for the past ten minutes, an integer value of the number of tasks staying in a queue, percentage data indicating a network bandwidth usage rate of each node, and the like. The management unit predicts a future load fluctuation using a mathematical model based on queuing theory. The management unit dynamically calculates a quota of a GPU memory to be allocated to each container based on this prediction result. The management unit outputs a scaling command vector for optimizing resource allocation as output data. Specific examples of the output data include a control signal indicating that three instances of a specific AI agent are added, flag data for temporarily stopping a task with a low priority, a setting value for changing an allocation amount of the GPU memory, and the like. The management unit transmits the scaling command vector to a container orchestration tool to dynamically change a configuration of a cluster as subsequent processing. The management unit analyzes a dependency graph of tasks and distributes tasks that can be executed in parallel to a plurality of agents. The management unit asynchronously collects a processing result of each agent and combines final output data. The system maximizes utilization efficiency of hardware by these dynamic resource management. The system brings about a technical effect of preventing system downtime and maintaining a stable throughput even against a sudden increase in traffic. The system exhibits extremely high usefulness in specific application fields such as back-end processing of a large-scale E-commerce site and a real-time financial transaction system. The system controls the system using a non-conventional method peculiar to a computer, which is analysis of time-series metrics and container orchestration, instead of a human administrator manually allocating resources.

Furthermore, when the user inputs feedback (for example, “make the wording of this invoice more polite”, “lower the difficulty level of this teaching material”, “add an interview with a family member to this care plan”, and the like) on the business processing result of the AI agent, the generative AI immediately learns the feedback and reflects the feedback in the business processing from next time onward. Thereby, the AI agent continues to finely adapt to preferences, a business style, and an actual situation of a site for each user. Specifically, the generative AI receives a natural language text of the feedback input by the user and a difference vector of output results before and after correction as input data. The generative AI inputs the feedback text to an emotion analysis model to extract an intention as preprocessing. Specific examples of the input data include text data indicating a request to make the wording more polite, a prompt character string instructing to lower the difficulty level, structured data of an interview schedule to be added, and the like. The generative AI updates a reward model using a reinforcement learning algorithm from human feedback. The generative AI calculates a policy gradient of a generative model using this reward model. The generative AI outputs a penalty score for correcting an output distribution of the model and an updated prompt template as output data. Specific examples of the output data include scalar data indicating a negative reward value for an inappropriate output, a policy gradient vector calculated by the reinforcement learning algorithm, a text character string of a system prompt used for generation from next time onward, and the like. The generative AI recalculates a loss function using the penalty score and executes parameter-efficient fine-tuning as subsequent processing. The generative AI vectorizes the content of the feedback and stores the vectorized content in a vector database. The generative AI searches this vector database at the time of next inference and dynamically adds similar past feedback to the prompt as a context. The system rapidly converges the output of the model to the intention of the user by these immediate learning mechanisms. The system brings about a technical effect of eliminating the need for large-scale batch processing for relearning and reducing calculation costs. The system exhibits extremely high usefulness in specific application fields such as creative content production support and advanced customer support business. The system adapts the model using a non-conventional method peculiar to a computer, which is calculation of a policy gradient by reinforcement learning and dynamic prompt generation, instead of simple text replacement.

As described above, in the embodiment of the present invention, the generative AI is used as an essential component, the server and the terminal closely cooperate, the AI agent optimized for each industry and business is provided via a network, and the AI agent continuously grows and evolves while flexibly and promptly responding to diverse business needs of the user, thereby enabling business efficiency improvement, business transformation, and creation of a new business method that could not be realized by conventional temporary staffing or outsourcing. Furthermore, a robust system configuration combining practicality and expandability from all viewpoints is realized, including incorporation into various devices such as home appliances, mobile phones, in-vehicle devices, and nursing care devices, support for various input formats such as sensor data, image data, and voice data, immediate learning reflection of user feedback, dynamic management of a plurality of agents, and security and privacy protection. Specifically, the system receives a multimodal data stream collected from a wide variety of devices as input data. The system unifies a format of the data stream and stores the data stream in a distributed messaging queue as preprocessing. Specific examples of the input data include voice waveform data input from a microphone of a smartphone, a continuous image frame tensor of an in-vehicle camera, a two-dimensional array obtained from a pressure sensor of a nursing care bed, and the like. The system routes these input data to a parallel processing pipeline and executes inference by each specialized AI model. The system outputs a vector group of an inference result and a control command optimized for each business as output data. Specific examples of the output data include numerical data of a KPI indicating a degree of business efficiency improvement, a numerical value indicating a duty ratio of a PWM signal for driving a device, binary data of a generated final business document, and the like. The system persists these output results in a database and visualizes the output results on a real-time dashboard as subsequent processing. The system adopts a hybrid architecture that dynamically switches between lightweight inference on an edge device and large-scale inference on a cloud. Thereby, the system minimizes an influence of a network delay and dramatically improves a throughput of the entire system. The system brings about a technical effect of maintaining inference accuracy while optimizing an operation cost by a combination of continuous learning and dynamic resource allocation. The system exhibits extremely high usefulness in specific application fields such as infrastructure management of a smart city and an integrated business platform of a global company. The system constructs a completely new information processing platform using a non-conventional method peculiar to a computer, which is tensor calculation of multimodal data and a distributed processing architecture, instead of simply digitizing a human business process.

### (System Configuration)

The system according to the present embodiment includes an agent allocation unit, a knowledge base management unit, a generative AI processing unit, a learning accumulation unit, a data storage unit, a management unit, a user interface unit, a local processing unit, a communication unit, and a security management unit.

The agent allocation unit has a function of receiving a business content designation and attribute information from a user, comprehensively determining an industry, a job type, a business content, a skill level, a past usage history, a current business load status, and the like of the user, and selecting and allocating an optimal AI agent, for example, when a user in general office work requests “creation of an invoice” or “automatic generation of meeting materials”, when a teacher in an educational field requests “creation of an individual guidance plan” or “automatic generation of teaching materials”, when an engineer requests “review of a design drawing” or “code review”, or when a nursing care worker requests “creation of a care plan” or “abnormality detection of vital data”. For example, when a plurality of businesses are requested simultaneously, it is also possible to allocate a plurality of AI agents concurrently and perform business distributed processing. Specifically, the agent allocation unit receives a natural language prompt including the business content designation of the user and a vector of the attribute information as input data. The agent allocation unit extracts a keyword from the prompt and digitizes complexity of a task as preprocessing. Specific examples of the input data include text data instructing creation of an invoice, numerical data indicating a past task completion rate of the user, a metrics array indicating a current load status of the system, and the like. The agent allocation unit inputs this input vector to a multilayer perceptron and calculates a fitness score of each agent. The agent allocation unit constructs a directed acyclic graph expressing a dependency relationship of tasks. The agent allocation unit analyzes this graph and specifies a task group that can be executed in parallel. The agent allocation unit outputs structured data indicating an identifier of the optimal AI agent and an amount of calculation resources to be allocated as output data. Specific examples of the output data include a UUID character string of an agent dedicated to financial processing, an integer value of the number of GPU cores to be allocated, enumerated data indicating a priority of a task, and the like. The agent allocation unit pulls a container image of the corresponding agent from a registry based on the identifier and constructs an execution environment as subsequent processing. The agent allocation unit simultaneously starts a plurality of agents using multi-thread processing and asynchronously dispatches tasks. The system minimizes a waiting time of a task by these advanced scheduling algorithms. The system brings about a technical effect of maximizing resource utilization efficiency of the entire system. The system exhibits extremely high usefulness in specific application fields such as a crowdsourcing platform where diverse requests are concentrated and a large-scale microservice architecture. The system allocates a task using a non-conventional method peculiar to a computer, which is analysis of a directed acyclic graph and scoring by a multilayer perceptron, instead of intuitive allocation by a human dispatcher.

The knowledge base management unit stores and manages a knowledge base pre-trained for each industry and business, and systematically manages a wide variety of business knowledge, such as past invoice data and a format necessary for creating an invoice, minutes and industry news necessary for creating meeting materials, a guidance plan and teaching material data in an educational field, a specification and a design drawing in a technical field, and a care record and medical data in a nursing care field, for example. The knowledge base management unit functions as an information source referred to by the AI agent when performing a business, and provides optimal knowledge in accordance with a business content and a user attribute. For example, even when the user uses a unique business procedure or a special format, the knowledge base management unit records and manages the pattern, and reflects the pattern in the business from next time onward. Specifically, the knowledge base management unit receives text data of a wide variety of business documents and a JSON object of metadata as input data. The knowledge base management unit chunks the text data for each semantic group and converts the text data into a high-dimensional vector using an embedding model as preprocessing. Specific examples of the input data include a text character string of past minutes, metadata including a creation date and time and a creator of a design drawing, text data extracted from a PDF of a medical guideline, and the like. The knowledge base management unit constructs an index of a hierarchical navigable small world graph using this high-dimensional vector. The knowledge base management unit calculates an inner product between a vector of a search query and a vector in the index, and executes a high-speed approximate nearest neighbor search. The knowledge base management unit outputs index data to be stored in a vector database and an array of similarity scores for the search query as output data. Specific examples of the output data include node information of a graph structure, an identifier list of top five documents having the highest similarity to the search query, a floating-point numerical value indicating a cosine similarity of each document, and the like. The knowledge base management unit inserts the searched document into a context window of the generative AI and executes retrieval-augmented generation as subsequent processing. When the user uses a unique format, the knowledge base management unit parses a structure of the document as an abstract syntax tree and registers the structure in a template database. The system extracts necessary information from a huge amount of unstructured data in milliseconds by these vector search technologies. The system brings about a technical effect of suppressing hallucination of the generative AI and ensuring accuracy of an answer. The system exhibits extremely high usefulness in specific application fields such as a knowledge management system of a large company in which internal regulations and manuals are frequently updated and a specialized precedent search system. The system manages knowledge using a non-conventional method peculiar to a computer, which is an approximate nearest neighbor search in a high-dimensional vector space, instead of a simple search by keyword matching.

The generative AI processing unit is a component forming a core of the present invention, implements a large-scale AI model such as a natural language processing model, an image generation model, a voice recognition/synthesis model, and a structured data analysis model, and generates an optimal output in accordance with a business content in response to a prompt sentence such as “please create an invoice”, “please automatically generate meeting materials”, “please analyze a grade transition for each student and create an individual guidance plan”, “please review a design drawing and point out an improvement point”, and “please detect an abnormality from vital data and propose a response plan”, for example. For example, for an invoice creation task, the generative AI processing unit inputs a prompt sentence “please refer to the following business partner information and past invoice data, and generate an invoice for this month. The format should conform to the attached file, and please also consider a consumption tax rate and a closing date.” to the generative AI, and automatically generates an accurate invoice. In automatic generation of meeting materials, a prompt sentence “please create meeting materials summarizing main points based on an agenda of a next meeting, a participant list, past minutes, and related industry news. Please also automatically insert a chart and a graph.” is used. In an educational field, a prompt sentence “please analyze grade transition data, attendance information, and a past guidance record of student A, and create an individual guidance plan. Please clearly describe a weak point and room for growth.” is used. In a technical field, a prompt sentence “please refer to this design drawing and a past design change history, and issue a review comment and an improvement proposal.” is used. In a nursing care field, a prompt sentence “please analyze vital data and a care record of user B, issue an alert if there is an abnormal value, and propose a response plan.” is used. Furthermore, when incorporated into a device such as home appliances, in-vehicle devices, and nursing care devices, a prompt sentence such as “please generate an optimal operation schedule of an air conditioner based on a current room temperature, humidity, and a life pattern of a user”, “please analyze an in-vehicle camera image and traffic information, and propose an optimal route”, and “please generate a calling content of a nursing care robot based on a health condition and a past action history of a user” is input to the generative AI. Specifically, the generative AI processing unit receives a combined tensor of a text character string of a prompt sentence and context information as input data. The generative AI processing unit converts the text character string into an array of token IDs using a byte pair encoding algorithm as preprocessing. Specific examples of the input data include a prompt character string instructing creation of an invoice, text data in a JSON format including past business partner information, a system prompt instructing abnormality detection of vital data, and the like. The generative AI processing unit inputs this token ID array to an embedding layer and converts the token ID array into a vector representation of continuous values. The generative AI processing unit adds positional encoding to this vector representation and inputs the vector representation to a self-attention layer of a transformer. The generative AI processing unit calculates an inner product of a query matrix and a key matrix, applies a softmax function, and calculates an attention weight. The generative AI processing unit multiplies a value matrix by this attention weight and extracts a feature vector considering a context. The generative AI processing unit outputs a logit tensor indicating a probability distribution of a token to be generated next as output data. Specific examples of the output data include a one-dimensional probability array having dimensions corresponding to a vocabulary size, top three candidate token IDs selected by a beam search algorithm, a finally decoded generated text character string, and the like. The generative AI processing unit inputs the generated text character string to a parser and verifies validity of a format as subsequent processing. The system maximizes an inference speed by executing these large-scale matrix calculations in parallel on a GPU cluster. The system brings about a technical effect of accurately understanding a complex context and instantaneously generating a document with quality equal to or higher than that of a human. The system exhibits extremely high usefulness in specific application fields such as a multilingual automatic translation service and an advanced interactive agent. The system generates a text using a non-conventional method peculiar to a computer, which is matrix calculation by a self-attention mechanism and sampling of a probability distribution, instead of imitating a human language understanding process.

The learning accumulation unit sequentially collects new business data, user-specific business know-how, a business flow, an irregular response case, feedback from a user, and the like obtained while the AI agent performs a business, and accumulates them as learning data of a knowledge base and generative AI. For example, when the user corrects the wording of an invoice, changes a configuration of meeting materials, customizes a content of a guidance plan, adds a unique viewpoint to a review comment of a design drawing, or adds a family interview to a care plan, data reflecting a business style and an actual situation of a site for each user is immediately recorded and reflected in business processing from next time onward. The learning accumulation unit functions as a foundation supporting continuous growth and evolution of the AI agent, and hierarchically manages data for each user, each industry, and each business. Specifically, the learning accumulation unit receives a tensor of a learning data set composed of a pair of an inference result of the AI agent and correct answer data as input data. The learning accumulation unit shuffles the data set and divides the data set into mini-batches as preprocessing. Specific examples of the input data include difference data between a generated invoice and an invoice finally approved by the user, a binary label indicating an output score of an abnormality detection model and actual presence or absence of abnormality occurrence, numerical data of a reward score given as feedback, and the like. The learning accumulation unit forward-propagates this mini-batch data to a neural network and calculates a cross-entropy error between a predicted value and a correct answer value. The learning accumulation unit back-propagates this error and calculates a gradient for a weight parameter of each layer. The learning accumulation unit updates the weight parameter using an adaptive moment estimation algorithm. The learning accumulation unit outputs a matrix of a weight update amount in each layer of the neural network as output data. Specific examples of the output data include an update tensor for a query weight matrix of an attention layer, an update vector for a bias term of a feed-forward layer, scalar data indicating an average loss value for each epoch, and the like. The learning accumulation unit stores the updated weight parameter in a storage as a checkpoint file of the model as subsequent processing. The learning accumulation unit stores the data in a distributed file system having a hierarchical directory structure and assigns a metadata tag. The system continuously improves accuracy of the model by these data pipelines and learning algorithms. The system brings about a technical effect of establishing tacit knowledge of the user as an explicit model parameter. The system exhibits extremely high usefulness in specific application fields such as a quality control department in a manufacturing industry where inheritance of know-how of an expert is an issue and a recommendation engine in which personalization is important. The system executes learning using a non-conventional method peculiar to a computer, which is gradient calculation by an error backpropagation method and optimization of a parameter space, instead of simple log recording.

The data storage unit has a function of safely storing learning data, a business history, feedback information, and the like even after a business period ends in accordance with a selection by the user, and restarting the AI agent in a state where the past learning data is taken over during subsequent uses. For example, the data storage unit stores a business history in a long-term project, a record of business improvements over a plurality of times, a unique format and a special business procedure input by the user in the past, a feedback history, and the like, and ensures reuse and business continuity. The data storage unit gives sufficient consideration to information leakage and privacy protection, and includes a security function such as encryption and access control. Specifically, the data storage unit receives a learned model parameter tensor and structured data of a business history as input data. The data storage unit serializes the data as preprocessing and reduces a data size using a lossless compression algorithm. Specific examples of the input data include a multidimensional array of floating-point numbers including billions of parameters, CSV data including a task execution log for the past month, XML data including user setting information, and the like. The data storage unit encrypts the compressed data in units of blocks using an advanced encryption standard algorithm. The data storage unit safely generates and manages a key used for the encryption in a hardware security module. The data storage unit outputs an encrypted binary data block and a hash value indicating data integrity as output data. Specific examples of the output data include an encrypted byte array, a 256-bit checksum character string calculated by a secure hash algorithm, a URI character string of an object storage of a storage destination, and the like. The data storage unit records the hash value in a blockchain network as subsequent processing to prevent data falsification. The data storage unit executes tiered storage management for automatically migrating data with a low access frequency to a cold storage. The system achieves both data confidentiality and availability by these encryption and distributed storage technologies. The system brings about a technical effect of safely persisting large-scale model parameters while optimizing a storage cost. The system exhibits extremely high usefulness in specific application fields such as an audit log system of a financial institution and an electronic medical record storage system of a medical institution, which require strict compliance requirements. The system protects data using a non-conventional method peculiar to a computer, which is not mere file storage but integrity verification by block encryption and a hash function.

The management unit performs overall management of the entire system, monitors an operation status and a load status of each unit, and executes optimal resource allocation, agent reallocation, automatic recovery at the time of failure occurrence, usage status analysis for each user, system optimization for business efficiency improvement, and the like. For example, it is also possible to allocate a plurality of AI agents simultaneously to perform distributed processing of a business during a busy period, and reduce the number of agents to achieve cost optimization during a slow period. The management unit is also responsible for responding to inquiries from users, system maintenance, version upgrade management, and the like. Specifically, the management unit dynamically controls system resources using a container orchestration technology. The management unit periodically samples a processor usage rate and memory consumption of each calculation node. The management unit acquires the sampled metrics data as a multidimensional time-series vector. The management unit inputs the time-series vector to a prediction model such as a long short-term memory network. The prediction model has learned a past load fluctuation pattern. The prediction model outputs a system load from several minutes to several hours later as a prediction score. The management unit compares the prediction score with a preset threshold value. The management unit automatically starts a new container instance when the prediction score exceeds the threshold value. The management unit distributes traffic to the started instance. The management unit thereby avoids load concentration on a specific calculation node. The management unit prevents a processing delay of the entire system. The management unit constantly executes a keep-alive monitoring process for detecting a hardware failure. When detecting a node with no response, the management unit immediately migrates a task on the node to another normal node. The management unit ensures high availability of the system by the failover processing. The management unit records the number of API calls and a processing time for each user as log data. The management unit aggregates the log data and analyzes a usage tendency. The management unit dynamically adjusts an allocation upper limit of calculation resources for each user based on the analysis result. The management unit thereby maintains resource fairness in a multi-tenant environment. The management unit adopts a blue-green deployment method when updating the system. The management unit operates old and new system environments in parallel. The management unit switches traffic to the new environment in stages. The management unit thereby completes a version upgrade of the system without causing downtime. These autonomous controls of the management unit completely replace manual system operation work by a human. The management unit dramatically improves operation efficiency of a large-scale parallel calculation cluster. The management unit realizes a technical improvement of resource management in a cloud computing environment.

The user interface unit provides an interface for the user to input and designate a business task, and supports various input means such as text input, voice input, image input, file upload, a selective UI, and a chatbot format. For example, a flexible UI according to a usage scene is realized, such as business instruction input by voice recognition in a smartphone or a tablet terminal, file attachment by drag and drop in a personal computer, and button operation or sensor-linked input in home appliances or in-vehicle devices. The user interface unit also provides display and notification of a business processing result, feedback input, a remind function, and the like. Specifically, the user interface unit functions as a front-end module that integrally processes multimodal input data. The user interface unit digitally samples an analog voice waveform acquired from a voice input device. The user interface unit converts the digital voice data into a frequency spectrum using a fast Fourier transform. The user interface unit extracts a mel-frequency cepstrum coefficient from the frequency spectrum. The user interface unit inputs the coefficient to an acoustic model for voice recognition. The acoustic model outputs a text character string from the input coefficient vector. The user interface unit normalizes pixel data acquired from an image input device. The user interface unit inputs the normalized image tensor to a convolutional neural network. The network outputs an object or a text region in an image as coordinate data of a bounding box. The user interface unit passes a character string acquired from a text input field to a natural language processing pipeline. The pipeline tokenizes the character string and generates a word embedding vector. The user interface unit maps feature vectors obtained from these different modalities to a single integrated feature space. The user interface unit transmits the integrated feature vector to a subsequent processing module. The user interface unit analyzes processing result data received from the server. The user interface unit dynamically renders a table or a graph when the processing result is structured data. The user interface unit draws the processing result on a screen as a three-dimensional model when the processing result is spatial data. The user interface unit records a user's line of sight or a trajectory of a touch operation as an event log. The user interface unit analyzes the event log and infers a user's intention. The user interface unit prefetches and displays an input form required next based on the inference result. The user interface unit thereby significantly reduces an input load on the user. The user interface unit provides consistent operability in various device environments. The user interface unit realizes a technical improvement of a human-machine interface.

The local processing unit executes a part of task processing and data preprocessing on the terminal, and performs, for example, image resizing and noise removal, voice data format conversion, simple OCR processing, primary processing of sensor data, and the like. Thereby, it is possible to reduce a data amount before transmitting data to the server, or mask personal information for privacy protection. The local processing unit optimizes a processing content in accordance with performance and a usage environment of the terminal. Specifically, the local processing unit plays a core role in an edge computing architecture. The local processing unit utilizes a dedicated inference accelerator mounted on the terminal. The local processing unit receives a high-resolution image tensor as an input. The local processing unit applies a bilinear interpolation algorithm to the image tensor. The local processing unit downscales a spatial resolution of the image. The local processing unit applies a Gaussian filter to the downscaled image. The local processing unit attenuates a high-frequency noise component. The local processing unit executes a lightweight object detection model on a local memory. The model detects, for example, a face region of a person. The model outputs coordinate data of the face region. The local processing unit performs a blacking-out process on a pixel value of the face region based on the coordinate data. The local processing unit thereby irreversibly masks personally identifiable information. The local processing unit applies a silent section detection algorithm to voice data. The local processing unit deletes a section in which a voice level is equal to or less than a certain threshold value. The local processing unit extracts only an effective voice section. The local processing unit encodes the extracted voice data using a highly efficient voice compression codec. The local processing unit applies a moving average filter to time-series raw data acquired from a sensor. The local processing unit removes sudden spike noise. The local processing unit packetizes only the data that has undergone these preprocessings and transmits the packetized data to the server. The local processing unit thereby reduces dependence on a broadband network. The local processing unit minimizes a communication delay. The local processing unit monitors a remaining battery level of the terminal and a temperature of a processor. The local processing unit skips a part of preprocessing tasks and delegates the tasks to the server side when there is no margin in resources. The local processing unit optimizes processing efficiency of the entire system by the dynamic task offloading. The local processing unit realizes a technical improvement of data flow control in a distributed processing system.

The communication unit is responsible for data transmission and reception between the terminal and the server, and safely and efficiently transmits various data such as a business task, a business processing result, learning data, feedback information, and sensor data. The communication unit also includes functions such as automatic retransmission at the time of a network failure, data compression, and encrypted communication. Specifically, the communication unit highly controls a protocol stack of a transport layer and a network layer. The communication unit divides data to be transmitted into fixed-length packets. The communication unit adds a sequence number and a checksum to a header of each packet. The communication unit applies a different Quality of Service profile depending on a type of data. The communication unit selects a low-delay UDP protocol for sensor data requiring real-time performance, for example. The communication unit selects a highly reliable TCP protocol for business task data requiring reliable arrival. The communication unit applies a high compression rate algorithm such as a Lempel-Ziv-Markov chain-Algorithm to a data payload before transmission. The communication unit thereby dramatically reduces consumption of a network bandwidth. The communication unit incorporates an encryption module. The communication unit encrypts the payload with a 256-bit length key by an Advanced Encryption Standard algorithm using the encryption module. The communication unit establishes a secure communication session with the server using a key exchange protocol. The communication unit constantly monitors a link state of a network interface. The communication unit dynamically adjusts a congestion control algorithm when detecting packet loss or an increase in delay. The communication unit reduces a transmission window size to reduce a load on the network. The communication unit temporarily buffers data waiting for transmission in a local non-volatile memory when communication is completely disconnected. The communication unit automatically retransmits the data in the buffer immediately upon detecting that a network connection is recovered. The communication unit completely prevents data loss during a temporary communication failure by the store-and-forward mechanism. The communication unit executes multipath routing when a plurality of communication paths exist. The communication unit distributes and transmits packets to a plurality of paths. The communication unit thereby ensures communication redundancy and improves throughput. The communication unit provides a technical improvement that dramatically enhances reliability and efficiency of data transmission in a distributed system.

The security management unit ensures security of the entire system, and implements multi-layered security measures such as user authentication and authorization, data encryption, access control, terminal lock, log management, and unauthorized access detection. For example, the security management unit performs encryption when storing and transmitting business data and learning data, sets an access authority for each user, and prevents information leakage and unauthorized use. Specifically, the security management unit constructs a strict access control mechanism based on a principle of a zero trust architecture. The security management unit requests multi-factor authentication when the user logs in. The security management unit receives biometric authentication data as an input in addition to knowledge information such as a password. The security management unit extracts a feature point vector from a fingerprint image acquired from a fingerprint sensor, for example. The security management unit collates the feature point vector with a registered template vector stored in a secure enclave. The security management unit calculates a Euclidean distance between both vectors. The security management unit permits authentication only when the distance is equal to or less than a predetermined threshold value. The security management unit issues a JSON Web Token with an expiration date to the user who has succeeded in authentication. The security management unit embeds role information of the user and scope information of an accessible resource in the token. The security management unit intercepts an API request to each module in the system. The security management unit verifies a signature of the token included in a request header. The security management unit authorizes or rejects execution of the request based on claim information of the token. The security management unit transparently encrypts all data stored in a database. The security management unit centrally manages a data encryption key by a key management service. The security management unit periodically rotates the encryption key. The security management unit records all events occurring in the system as an audit log. The security management unit stores the audit log in an append-only storage using a hash chain structure. The security management unit thereby makes falsification of the log mathematically impossible. The security management unit constantly monitors network traffic and an API call pattern. The security management unit inputs the monitoring data to an autoencoder model for abnormality detection. The model has learned a normal behavior pattern. The model outputs a reconstruction error for the input data. The security management unit determines that there is a suspicion of unauthorized access when the reconstruction error exceeds a threshold value. The security management unit immediately forcibly disconnects a corresponding session and transmits an alert to an administrator. The security management unit significantly improves robustness of a computer system in an information security field.

Specific examples of a prompt sentence to be read by the generative AI when carrying out the present invention include “Please refer to the following business partner information and past invoice data, and generate an invoice for this month. The format should conform to the attached file, and please also consider a consumption tax rate and a closing date.”, “Please create meeting materials summarizing main points based on an agenda of the next meeting, a participant list, past minutes, and related industry news. Please also automatically insert charts and graphs.”, “Please analyze grade transition data, attendance information, and a past guidance record of student A, and create an individual guidance plan. Please clearly describe weaknesses and room for growth.”, “Please refer to this design drawing and a past design change history, and issue a review comment and an improvement proposal.”, “Please analyze vital data and a care record of user B, issue an alert if there is an abnormal value, and propose a response plan.”, “Please generate an optimal operation schedule of an air conditioner based on a current room temperature, humidity, and a life pattern of the user.”, “Please analyze an in-vehicle camera image and traffic information, and propose an optimal route.”, “Please generate a calling content of a nursing care robot based on a health condition and a past action history of the user.”, and the like. These prompt sentences are automatically generated in accordance with a business content and a usage environment of the user, and are input to the generative AI, whereby an optimal business processing result is obtained. Specifically, the system mechanically constructs these texts using a dynamic prompt engineering technology. The system includes a prompt generation engine. The engine holds a prompt template optimized for each type of task. The engine parses input structured data. The engine extracts, for example, business partner information and past invoice data described in a JSON format as a key-value pair. The engine inserts the extracted data into a placeholder of the template. The engine considers a limitation of a context window of a large language model. The engine applies a text summarization algorithm to compress a data size when a data amount to be inserted exceeds the limitation. The engine adds a system prompt to the head of the prompt. The system prompt instructs the AI model on a specific persona and a constraint on an output format. The engine designates, for example, a Markdown notation or a specific XML schema as the output format. The engine adds several specific examples for Few-Shot prompting to the end of the prompt. The engine thereby improves stability and accuracy of an output of the model. The engine inputs the generated prompt character string to a tokenizer. The tokenizer converts the character string into an integer token ID array processable by the model. The system supplies the token ID array to an input layer of the generative AI model. The model is, for example, a neural network having billions of parameters based on a Transformer architecture. The model analyzes a context of the input token string using a self-attention mechanism. The model outputs an optimal token that follows next as a probability distribution. The system selects a token string having the highest likelihood from the probability distribution using a beam search algorithm. The system decodes the selected token string and generates a final text and structured data. The system completely automates these processings. The system eliminates a process in which a human manually performs trial and error on a prompt. The system provides a technical improvement of a data processing method for maximizing an inference capability of the AI model.

### (Implementation Steps)

Step 1: Input of user information and business task The user inputs attribute information such as his/her own industry, job type, business content, skill level, and past usage history via the user interface unit on the terminal, and further inputs or selects a specific business task such as “creation of an invoice”, “automatic generation of meeting materials”, “grade analysis for each student”, “review of a design drawing”, and “creation of a care plan”. For example, a user in office work can input “I want to create an invoice for this month”, and a user in an educational field can input “I want to create an individual guidance plan for student A”. Specifically, in this step, the local processing unit of the terminal converts the input information into a structured data object. The local processing unit stores the attribute information of the user in a key-value type dictionary data structure. The local processing unit executes morphological analysis on a natural language text of the input business task. The local processing unit extracts a keyword of a verb or a noun indicating an intention of the task from the text. The local processing unit determines a category ID for classifying the task based on the keyword. The local processing unit combines the dictionary data of the attribute information and the category ID. The local processing unit serializes the combined data into a payload in a JSON format. The local processing unit adds a time stamp and a unique session ID to the payload. The local processing unit writes the payload to a transmission buffer on a memory. The communication unit of the terminal reads the payload from the buffer. The communication unit encrypts the payload and transmits the payload to an endpoint of the server via a secure HTTPS connection. A receiving module of the server receives the payload. The receiving module verifies a format of the payload. The receiving module registers the successfully verified data in a message queuing system. The system thereby asynchronously and scalably processes a large amount of simultaneous input requests. The system prevents loss of input data and reversal of an order. The system provides a standardized data format to a subsequent processing module. The system realizes a technical improvement that enhances certainty and efficiency of information processing in a data input phase.

Step 2: Agent allocation and knowledge base reference The agent allocation unit on the server side selects and allocates an optimal AI agent based on the received user information and business task content. The allocated AI agent refers to pre-trained data, a past business history, a related format and regulation, industry knowledge, and the like necessary for the corresponding industry and business from a knowledge base management unit, and prepares for task processing. For example, past invoice data and business partner information are referred to in the case of invoice creation, a past guidance record and grade data are referred to in an educational field, a design drawing and a specification are referred to in a technical field, and a care record and vital data are referred to in a nursing care field. Specifically, the agent allocation unit generates a feature vector of the task from the received payload. The agent allocation unit maps the feature vector to a multidimensional vector space. The system holds a profile vector expressing a specialized area and a processing capability of each AI agent in a database in advance. The agent allocation unit calculates a cosine similarity between the feature vector of the task and the profile vector of each agent. The agent allocation unit dynamically selects an agent having the maximum similarity score. The agent allocation unit allocates an inference model most suitable for a nature of the task by the selection process. The knowledge base management unit drives a vector database engine. The knowledge base management unit constructs an identifier of the selected agent and a keyword of the task as a query. The knowledge base management unit executes an approximate nearest neighbor search on a vector database using the query. The knowledge base management unit extracts an embedding vector of past business data and a document highly relevant to the task at high speed by the search. The knowledge base management unit reads an actual data record corresponding to the extracted embedding vector from a storage. The knowledge base management unit loads the actual data record into a cache area on a memory. The knowledge base management unit maps the loaded data to a shared memory space accessible by the agent. The system thereby acquires necessary context information from a large-scale knowledge base with a low delay in units of milliseconds. The system makes a data preparation phase before the AI agent starts inference extremely efficient. The system provides a technical improvement in an algorithm of information retrieval and resource allocation.

Step 3: Business processing prompt generation by generative AI. The agent allocation unit and a knowledge base management unit automatically generate a prompt sentence to be input to the generative AI based on a business task content of a user and reference data. For example, prompt sentences are generated, such as “Please refer to the following business partner information and past invoice data, and generate an invoice for this month. The format should conform to the attached file, and the consumption tax rate and the closing date should also be considered.” in the case of an invoice creation task, “Please create meeting materials summarizing main points based on an agenda of the next meeting, a participant list, past minutes, and related industry news. Please also automatically insert charts and graphs.” in the case of meeting material creation, “Please analyze grade transition data, attendance information, and past guidance records of student A, and create an individual guidance plan. Please clearly describe weaknesses and room for growth.” in an educational field, “Please refer to this design drawing and a past design change history, and output review comments and improvement proposals.” in a technical field, and “Please analyze vital data and a care record of user B, issue an alert if there is an abnormal value, and propose a response plan.” in a nursing care field. Specifically, the prompt generation unit serializes the extracted reference data into a format understandable by a natural language model. When the reference data is a tabular database record, the prompt generation unit converts each row into a comma-separated text character string. When the reference data is an image, the prompt generation unit generates text describing features of the image using an image captioning model. The prompt generation unit combines these converted text data with a task instruction sentence. In this combining process, the prompt generation unit clearly separates a boundary between the instruction sentence and the reference data using a specific markup tag. Thereby, the prompt generation unit enables an AI model to accurately separate and recognize a context. The prompt generation unit counts the number of tokens of the entire generated text. The prompt generation unit determines whether or not this number of tokens exceeds a maximum input token length of the AI model. When the number of tokens exceeds the maximum input token length, the prompt generation unit calculates an importance of each sentence in the reference data using an importance scoring algorithm. The prompt generation unit deletes sentences in ascending order of importance. By this truncation processing, the prompt generation unit fits the input data within a limit of the model. The prompt generation unit finally generates an optimized text character string. The prompt generation unit inputs this character string to a tokenizer based on a byte-pair encoding algorithm. The tokenizer converts the character string into an input tensor that is an array of integers. The system completes preparation for passing this input tensor to an inference pipeline of the generative AI. By these data shaping and optimization processings, the system maximizes inference accuracy and calculation efficiency of the AI model. The system realizes a technical improvement of input data preprocessing in a natural language processing system.

Step 4: Business task processing by generative AI. A generative AI processing unit receives the prompt sentence and the reference data as inputs, and generates an optimal output for the business task of the user by making full use of functions such as natural language processing, image generation, voice recognition, and data analysis. For example, accurate invoice data is automatically generated in the invoice creation task, materials summarizing main points and charts are automatically generated in the meeting material creation, an individual guidance plan and teaching materials are automatically generated in the educational field, review comments and improvement proposals are automatically generated in the technical field, and a care plan and an alert notification are automatically generated in the nursing care field. Specifically, the generative AI processing unit executes a large-scale neural network model on a parallel computing cluster using GPUs. The processing unit supplies the input tensor to an embedding layer of the model. The embedding layer maps each token ID to a high-dimensional continuous vector space. The processing unit adds positional encoding to this vector sequence. The processing unit sequentially passes this data through dozens of layers of Transformer blocks. A multi-head self-attention mechanism in each Transformer block calculates a dependency relationship between tokens. The mechanism generates a hidden state vector capturing a context of the entire input sequence. The processing unit inputs this hidden state vector to a feed-forward neural network. The processing unit applies a non-linear transformation. The processing unit inputs an output vector of a final layer to a softmax function. The function calculates an appearance probability distribution for all tokens in a vocabulary set. The processing unit selects a next token from this probability distribution using a sampling algorithm. The processing unit adds this selected token to the end of the input sequence. The processing unit autoregressively repeats this process until an end token is generated. In the case of an image generation task, the processing unit drives a latent diffusion model. The model starts from a random noise tensor. The model uses a text embedding vector as conditioning. The model converts the noise tensor into a meaningful image latent representation through a plurality of denoising steps. The processing unit inputs this latent representation to a decoder to generate final pixel data. In the case of a data analysis task, the processing unit extracts an executable code snippet such as Python included in the generated text. The processing unit executes this code within a secure sandbox environment. The processing unit integrates the execution result into the final output. By these advanced arithmetic processings, the system autonomously completes a complex task imitating a human cognitive process. The system provides a technical improvement in information generation and problem-solving capabilities by a computer.

Step 5: Output of business processing result and presentation to user. The business processing result generated by the generative AI is transmitted from the server to a user interface unit of the terminal, and is presented to the user in various formats such as text, a table, a graph, an image, voice, a PDF file, and a notification message. For example, invoice data is displayed in a PDF or tabular format, meeting materials are displayed in a slide format, an individual guidance plan is displayed in text or a table, a design review is displayed in a comment list, and a care plan is displayed in a checklist or an alert notification. Specifically, an output formatter module of the server decodes a raw token sequence output from the generative AI. The module analyzes the decoded text data. The module extracts structured metadata such as Markdown notation and HTML tags included in the text. The module determines a data rendering method based on this metadata. When the output is tabular data, the module parses a comma-separated character string and converts it into a two-dimensional array data structure. The module serializes this array data into a JSON format. When the output requests graph drawing, the module generates an array of data points and calls an API of a graph drawing library. The module generates vector-format image data. When the output is a PDF document, the module maps text and image data to a designated layout template. The module drives a PDF generation engine to construct a binary file. A communication unit of the server transmits various data formatted in this way to the terminal as an HTTP response. The user interface unit of the terminal receives this response. The user interface unit utilizes a graphics processing unit of the terminal. The user interface unit draws pixels on a screen at high speed based on the received data. When receiving voice data, the user interface unit reproduces voice from a speaker via a digital-to-analog converter. When receiving an alert notification, the user interface unit calls a notification API of an operating system. The user interface unit displays a pop-up on the screen and drives a vibration motor of the terminal. By these processings, the system converts an abstract calculation result into a physical stimulus that a human can intuitively understand. The system realizes a technical improvement that enhances diversity and immediacy of information presentation.

Step 6: User feedback and learning accumulation of business data. The user can input a correction, an additional instruction, and feedback to the business processing result, and gives an instruction such as “I want to change the wording of this invoice”, “I want to insert additional materials into the meeting materials”, “I want to adjust the difficulty level of the guidance plan”, “I want to add a unique perspective to the review comments”, and “I want to add a family interview to the care plan”, for example. These feedbacks and correction contents are recorded in the learning accumulation unit, accumulated as learning data of the generative AI, and immediately reflected in business processing from next time onward. Specifically, the user interface unit of the terminal captures a text editing operation and a button click event performed by the user on the screen. The user interface unit extracts a difference between data before correction and data after correction from this operation history. The user interface unit encodes this difference data as a feedback vector. The terminal transmits this feedback vector to the server. The learning accumulation unit of the server receives this feedback vector. The learning accumulation unit pairs this vector with the original prompt input tensor. The learning accumulation unit formats this pair as a teacher data set. The learning accumulation unit additionally saves this teacher data in a database. The system implements proximal policy optimization, which is a kind of reinforcement learning algorithm. The system evaluates a correction operation by the user as a negative reward. The system evaluates an operation in which the user approves the result without making a correction as a positive reward. The system updates a weight parameter of a reward model using this reward signal. The system executes fine-tuning of the generative AI model as a background process using the updated reward model. The system calculates a gradient of each layer of the AI model using a backpropagation method. The system fine-tunes parameters of the model using an optimization algorithm. By this online learning mechanism, the system brings an output distribution of the model closer to the user's preference. The system continuously improves adaptability of the model to a specific domain or an individual business style. The system provides a technical improvement of a machine learning pipeline that dynamically evolves a static inference model.

Step 7: Storage and continuous utilization of learning data. When the user selects to store the learning data after the business period ends, the data storage unit safely stores a business history, feedback information, correction contents, a unique format, a special business procedure, and the like, and restarts the AI agent in a state where the past learning data is taken over at the time of use from next time onward. Thereby, continuous business efficiency improvement and personalization are realized even in a long-term project or a business spanning a plurality of times. Specifically, the data storage unit persists large-scale learning data using a distributed file system. The data storage unit serializes a user profile vector and a difference weight tensor of a fine-tuned model accumulated on a memory. The data storage unit applies a hash function to this serialized binary data. The data storage unit generates a checksum for verifying data integrity. The data storage unit encrypts this binary data using an encryption algorithm. The data storage unit distributes and writes this encrypted data to a plurality of physical drives in a storage cluster. The data storage unit applies an erasure coding technology to ensure data redundancy. The data storage unit updates a metadata server. The metadata server manages an index linking a user ID and a physical storage location of the stored data. When the user starts a next session, a management unit issues a query to this metadata server. The management unit acquires the storage location of the corresponding data. The management unit reads the encrypted data from the storage cluster. The management unit decrypts and deserializes this data. The management unit reloads this data into a memory space of an execution environment of the AI agent. The management unit adds the stored difference weight tensor to a weight tensor of a base model. By this processing, the management unit instantly restores a personalized model specialized for the user. By this stateful session management mechanism, the system ensures continuity of memory of the agent. The system realizes a technical improvement that achieves both maintenance of a long-term context and efficient utilization of calculation resources.

### (Specific Use Case)

For example, in general office work, when the user inputs “I want to create an invoice for this month” using the user interface unit of the terminal, and uploads or designates related data such as business partner information, transaction contents, a billing amount, a consumption tax rate, a closing date, payment conditions, past invoice data, and a company-specific invoice format, the agent allocation unit determines that the user's industry is general office work, the business content is invoice creation, and a past usage history and a company-specific format exist, and allocates an optimal AI agent. The knowledge base management unit refers to past invoice data, special notes for each business partner, a change history of the consumption tax rate, regulations regarding the closing date and payment conditions, the company-specific invoice format, and the like, and automatically generates a prompt sentence to be input to the generative AI. The generative AI processing unit automatically generates invoice data using a prompt sentence such as “Please refer to the following business partner information, transaction contents, billing amount, consumption tax rate, closing date, payment conditions, past invoice data, and company-specific invoice format, and generate an invoice for this month. The format and wording should conform to the attached file, and the consumption tax rate and the closing date should also be considered.”, for example. The generated invoice is presented to the user in a PDF file or a tabular format, and the user can confirm the contents and input a wording correction or an additional instruction as necessary. When the user inputs feedback such as “I want you to add ‘Special discount applied this month’ to the remarks column of this invoice”, the learning accumulation unit records this correction content, and automatically reflects it when a similar condition occurs at the time of invoice creation from next time onward. Specifically, in this operation example, the system expands the uploaded related data on a memory as a multidimensional tensor. The system normalizes numerical fields such as business partner information and amount data. The system encodes these structured data into a token sequence processable by a large language model. The agent allocation unit loads a specialized model fine-tuned specifically for form generation based on a task classification result. The knowledge base management unit extracts a past similar transaction record using a vector search engine. The knowledge base management unit embeds this record into the prompt as a context. The generative AI processing unit receives this prompt as an input. The generative AI processing unit calculates a dependency relationship between each data item using a self-attention mechanism. The generative AI processing unit internally executes logic of tax rate calculation, for example. The generative AI processing unit generates a pair of a text character string corresponding to each item of the invoice and coordinate data on a layout as an output. A subsequent processing unit of the system drives a PDF generation library based on this coordinate data. The subsequent processing unit accurately maps the text onto the designated company-specific template. The system transmits the generated PDF binary to the terminal. The display unit of the terminal renders this PDF. When the user inputs text instructing an addition to the remarks column, the terminal analyzes this text with a natural language processing module. The terminal generates a vector specifying an intention of the addition and a target location. The learning accumulation unit registers this vector in a database as a new learning sample. The learning accumulation unit fine-tunes weights of the model using this sample. Thereby, the system acquires tacit knowledge such as a discount condition for a specific business partner as a parameter of the model. The system provides a technical improvement that highly automates routine office work and dramatically improves accuracy and efficiency of data processing.

For example, in the educational field, when the user inputs “I want to create an individual guidance plan for student A”, and designates grade transition data, attendance information, past guidance records, school of choice information, aptitude test results, requests from parents, educational guidance guidelines of a school, and the like of the student, the agent allocation unit allocates an AI agent in the educational field, and the knowledge base management unit refers to past guidance plans, learning achievement level data, educational guidance guidelines, latest educational trends, and the like. The generative AI processing unit inputs a prompt sentence such as “Please analyze grade transition data, attendance information, past guidance records, school of choice information, aptitude test results, requests from parents, and educational guidance guidelines of student A, and create an individual guidance plan. Please clearly describe weaknesses and room for growth, and also propose a future learning plan.” to the generative AI, and automatically generates an individual guidance plan. The generated guidance plan is presented in text or a tabular format, and the user can confirm the contents and input an additional instruction such as “Since this student is weak in mathematics, I want you to describe a learning plan for mathematics in more detail”, for example. The learning accumulation unit records this feedback, and automatically reflects it in a similar case. Specifically, in this operation example, the system acquires the grade transition and attendance information of the student as time-series numerical array data. The system inputs this time-series data to a recurrent neural network such as a long short-term memory network. The network outputs a score predicting a future grade fluctuation from a past data pattern. The system calculates a difference between this predicted score and a passing standard score of the school of choice. The system expresses this difference as a multidimensional issue vector. The knowledge base management unit searches a database of educational guidance guidelines using this issue vector. The knowledge base management unit extracts text data of a unit or a learning item to be overcome. The generative AI processing unit receives a prompt integrating this extracted text data and attribute data of the student as an input. The generative AI processing unit executes an inference engine of a large language model. The engine constructs logical learning steps based on the input context. The engine calculates a learning time to be allocated to each step and generates a data structure of a schedule table. The engine outputs a structured JSON object including text of weakness analysis and the schedule table. The system parses this JSON object and renders it as a graphical guidance plan on the screen of the terminal. When the user inputs text requesting detailing of the learning plan for mathematics, the system re-inputs this text to the model as a new prompt. The system generates a learning task in a deeper hierarchy specialized for a mathematics unit. The learning accumulation unit stores a pair of this series of dialogue history and the finally approved guidance plan as learning data. The system executes fine-tuning of a model specialized for an educational domain using this data. Thereby, the system realizes a technical improvement that optimizes a guidance plan creation process, which has relied on a teacher's rule of thumb, with a data-driven approach.

For example, in the technical field, when the user inputs “I want to create a specification document for a new product”, and designates a design drawing, a bill of materials, a past specification document, related technical literature, a design change history, a development schedule, and the like, the agent allocation unit allocates an AI agent in the technical field, and the knowledge base management unit refers to past specification documents, design drawings, a parts database, technical papers, design change histories, and the like. The generative AI processing unit inputs a prompt sentence such as “Please refer to a design drawing, a bill of materials, a past specification document, related technical literature, a design change history, and a development schedule, and create a specification document for a new product. Please cover necessary items and also reflect latest technical trends.” to the generative AI, and automatically generates a specification document. The user can confirm the specification document and input feedback such as “I want you to add a description regarding safety standards to this specification document”, and the learning accumulation unit records this and reflects it at the time of specification document creation from next time onward. Specifically, in this operation example, the system constructs a multimodal data processing pipeline. The system reads the input design drawing as a two-dimensional image tensor. The system inputs this image tensor to a convolutional neural network. The network extracts geometric features and dimension data in the drawing to generate a feature vector. The system inputs text data of the bill of materials and the technical literature to a natural language processing model. The model generates a word embedding vector from these texts. The system integrates the feature vector of the image and the embedding vector of the text in a combining layer. The system inputs this integrated multimodal vector to a Transformer model of the generative AI processing unit. The model calculates a correlation between visual information of the drawing and linguistic information of the bill of materials using a self-attention mechanism. The model generates technical text to be described in each section of the specification document based on this correlation. The model infers a durability spec required for a specific part from material information of the part and arrangement information on the drawing, for example, and converts it into text. The system formats the generated text into a hierarchical document structure. The system transmits this document to the terminal. When the user instructs addition of a description regarding safety standards, the system accesses an external standard database. The system acquires article data of related safety standards. The system re-inputs this article data to the model as a context and regenerates text of a corresponding section. The learning accumulation unit records this correction process as graph-structured data. The system causes the model to learn essential description items in a specific product category using this record. The system provides a technical improvement that automates a creation process of a technical document requiring advanced specialized knowledge and dramatically reduces a workload of an engineer.

For example, in the nursing care and welfare field, when the user inputs “I want to create a care plan for user B”, and designates a health condition, vital data, a past care record, a family structure, hobbies and preferences, medical data, a life pattern, and the like of the user, the agent allocation unit allocates an AI agent in the nursing care field, and the knowledge base management unit refers to past care plans, medical data, life pattern data, family structure information, and the like. The generative AI processing unit inputs a prompt sentence such as “Please analyze a health condition, vital data, a past care record, a family structure, hobbies and preferences, medical data, and a life pattern of user B, and create an optimal care plan. Please also propose a recreation plan and a report for a family member as necessary.” to the generative AI, and automatically generates a care plan. The user can confirm the care plan and input an instruction such as “I want you to add a schedule for a family interview to this care plan”, and the learning accumulation unit records this and reflects it at the time of care plan creation from next time onward. Specifically, in this operation example, the system receives vital data continuously transmitted from a wearable sensor as a time-series numerical stream. The system applies an anomaly detection algorithm to this stream data. The system sets a flag when a fluctuation in heart rate or blood pressure deviates from a statistical normal range. The system integrates this flag information and text data of a past care record. The system converts this integrated data into an input tensor of a large language model. The knowledge base management unit searches for an embedding vector of a similar case or a past successful care plan using a vector database. The generative AI processing unit receives this search result as a context. An inference engine of the generative AI processing unit analyzes a complex causal relationship between input data. The engine calculates a correlation between a specific vital fluctuation and a past fall incident, for example. The engine generates text of a care plan including a preventive intervention measure based on this analysis result. The engine simultaneously calculates a score indicating a priority of each task. The system sorts items of the care plan based on this score and displays them on the terminal. When the user instructs addition of a schedule for a family interview, the system calls a calendar API. The system searches for free time of related parties and automatically schedules an optimal interview date and time. The system integrates this schedule information into a data structure of the care plan. The learning accumulation unit stores this series of operation history and final care plan data as a teacher signal. The system updates a weight parameter of a nursing care domain-specialized model using this data. Thereby, the system realizes personalized care management that dynamically adapts to a state change of an individual user. The system provides a technical improvement of a data-driven decision support system in a nursing care field.

For example, when the present invention is incorporated into home appliances or in-vehicle devices, and a user inputs “I want to automatically generate an optimal operation schedule for an air conditioner” or “I want an optimal route to be proposed by an in-vehicle device” and designates a room temperature, a humidity, a life pattern of the user, an outside air temperature, a past driving history, traffic information, destination information, and the like, the agent allocation unit allocates an AI agent for the home appliances or the in-vehicle devices, and the knowledge base management unit refers to past driving data, life pattern data, traffic information data, and the like. The generative AI processing unit inputs a prompt sentence such as “Please generate an optimal operation schedule for the air conditioner based on the current room temperature, humidity, life pattern of the user, and outside air temperature.” or “Please analyze an in-vehicle camera image, traffic information, a past driving history, and destination information, and propose an optimal route.” to the generative AI, and automatically generates an optimal control command and route proposal. The user can confirm the result and input an instruction such as “I want an outing schedule to be considered in this schedule” or “I want a break point to be added to this route”, and the learning accumulation unit records this and reflects it in proposals from next time onward. Specifically, in this operation example, the system processes multidimensional environmental sensor data collected from an IoT device group in real time. The system drives a reinforcement learning agent in controlling the air conditioner. The agent observes the current room temperature and humidity as a state vector. The agent calculates an action value function that maximizes a comfort level of the user while minimizing power consumption. The agent outputs a time-series control command array of a set temperature and an air volume based on this function. The system transmits this command array to a control unit of the device. The system combines a graph search algorithm and a deep learning model in the route proposal of the in-vehicle device. The system expands a road network on a memory as a graph structure of nodes and edges. The system dynamically updates real-time traffic congestion information and weather data as a weight cost of each edge. The system inputs an image tensor acquired from the in-vehicle camera to a convolutional neural network. The network detects a road surface condition and an obstacle, and calculates an additional cost penalty. The system executes an A* search algorithm using these pieces of cost information. The system calculates a sequence of nodes that minimizes a total cost from a departure place to a destination as an optimal route vector. The generative AI processing unit converts this route vector into a navigation instruction text in natural language. When the user instructs the addition of a break point, the system searches a facility database around the route. The system inserts an optimal facility as a waypoint into the route vector based on past preference data of the user, and executes recalculation. The learning accumulation unit updates the reinforcement learning model using this feedback as a reward signal. The system realizes a technical improvement of a cyber-physical system that tightly couples sensor data in a physical space and arithmetic processing in a cyber space.

In this way, the system of the present invention allocates an AI agent optimized for each industry and business, the knowledge base management unit refers to related data, the generative AI processing unit automatically processes a business task using a prompt sentence, and the learning accumulation unit records and reflects user feedback, thereby realizing highly accurate and personalized business support in all fields and businesses. Specifically, the system adopts a Mixture of Experts architecture that dynamically switches a plurality of expert AI models specialized and fine-tuned for each domain, instead of depending on a single huge general-purpose model. The system inputs a feature vector of the input task to a router network. The router network classifies an intent of the task and routes an inference request to the most suitable expert model. Each expert model holds its own weight parameter and a domain-specific knowledge graph. The system achieves both extremely high expertise and accuracy while suppressing consumption of calculation resources during inference by this distributed approach. The system operates a vector database and a graph database in a hybrid manner in the knowledge base management unit. The system combines a search based on semantic similarity of data and a search based on a relationship between entities. The system thereby provides richer and more accurate context information to the AI model. The system introduces a federated learning method in the learning accumulation unit. The system aggregates only gradient data of the model calculated in a local environment of each terminal to the server. The system updates a global model without transmitting raw data to the server. The system thereby continuously evolves intelligence of the entire system while strictly protecting privacy. The system expands human cognitive ability by integrating these advanced computer technologies. The system provides a technical improvement that brings about a paradigm shift in automation and optimization of information processing.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

As an embodiment for carrying out the present invention, an extremely specific and detailed configuration and an operation example of an AI care management system in a nursing care field will be described. The system is constructed by linking a server and a terminal (a tablet, a smartphone, a nursing care robot, a personal computer, a wearable device, a sensor-embedded bed, or the like) via a network. A data management unit, a generative AI processing unit, a learning accumulation unit, a user management unit, a security management unit, a communication unit, an external cooperation unit, an analysis and prediction unit, and the like are provided on a server side, and a user interface unit, a local processing unit, a sensor cooperation unit, a notification unit, a voice input/output unit, an image input/output unit, and the like are provided on a terminal side. Specifically, the system adopts a distributed computing architecture for processing streaming data generated at a high frequency in real time. The sensor cooperation unit arranged on the terminal side of the system samples an analog signal output in milliseconds from the wearable device or the sensor-embedded bed into digital data using an analog-to-digital converter. The local processing unit of the terminal applies an edge computing technology to this enormous amount of raw data. The local processing unit removes noise using a signal processing algorithm such as a Kalman filter. The local processing unit extracts a feature vector of heart rate variability and a respiration pattern from a data stream. The local processing unit packetizes only this feature vector and transmits it to the server. The system thereby dramatically reduces consumption of a network bandwidth and minimizes a communication delay. The communication unit on the server side receives this packet. The data management unit of the server writes this feature vector to a time-series database at high speed. The analysis and prediction unit of the server inputs this time-series data to a recurrent neural network. The network predicts a state deterioration risk several hours later as a probability score from a past data transition. The generative AI processing unit of the server integrates this prediction score and electronic medical record data of the user acquired from the user management unit. The generative AI processing unit inputs this integrated data to a large language model. The model generates a specific intervention instruction text for avoiding the risk. The external cooperation unit of the server converts the generated instruction text into a standardized medical information exchange protocol. The external cooperation unit securely transfers this data to a system of an affiliated medical institution. The system shortens a latency from data collection to analysis and decision making in the nursing care field to the utmost limit by close cooperation between these hardware and software. The system realizes a technical improvement of an information processing system in a critical environment involving human life.

The data management unit centrally manages a basic profile (name, age, gender, nursing care level, past medical history, allergy, medication information, family structure, emergency contact, hobbies and preferences, life pattern, religious and cultural consideration, presence or absence of dementia, presence or absence of physical disability, past hospitalization and discharge history, fall history, infectious disease history, vaccination history, and the like), vital data (body temperature, blood pressure, pulse, SpO2, body weight, blood glucose level, respiratory rate, electrocardiogram data, sleep apnea detection, number of steps, activity amount, meal intake amount, number of excretions, urination and defecation state, skin state, presence or absence of bedsore, pain scale, swallowing function evaluation, oral care record, and the like), a past care history (meal content, rehabilitation record, medication history, excretion record, sleep status, recreation participation history, psychological state record, family interview record, medical treatment record, infectious disease countermeasure record, emergency response history, accident and near-miss record, outing and overnight stay record, intra-facility movement history, and the like), a facility schedule (meal time, bathing time, rehabilitation time, recreation time, visiting time, night monitoring schedule, staff shift, cleaning and disinfection schedule, equipment inspection schedule, and the like), weather information (temperature, humidity, atmospheric pressure, precipitation, weather forecast, heatstroke warning information, influenza epidemic information, and the like), a contact matter from a medical worker or a family member (doctor's instruction, nurse's handover, request from a family member, visiting request, medication change request, emergency contact change, family event information, and the like), nursing care insurance information (certification category, usage limit amount, service usage history, care manager information, notification from an administration, and the like), and all other information necessary for facility operation for each user. For example, when a user A has a past medical history of high blood pressure and diabetes, has hobbies of coloring and music appreciation, has a family consisting of an eldest son and an eldest daughter, and requires religious consideration, all of this information is recorded in the data management unit. For example, when a user B has dementia, has a wandering tendency, and has a history of falling multiple times in the past, a fall risk evaluation and data of a wandering detection sensor are also managed in time series. Specifically, the data management unit constructs a hybrid database structure for integrally storing heterogeneous data. The data management unit inputs a basic profile and a contact matter in a text format to a natural language processing model. The natural language processing model converts the input text data into a fixed-length embedding vector. For example, the model converts the text data into a 768-dimensional floating-point vector. The data management unit stores this embedding vector in a vector database area. Further, the data management unit stores vital data and sensor data in a time-series database area. The data management unit structures these numerical data as a two-dimensional tensor composed of a time step and a feature dimension. For example, the data management unit records data of body temperature, blood pressure, and pulse every hour for the past 24 hours as a numerical tensor of 24 rows and 3 columns. The data management unit relationally links the vector data and the time-series tensor using a unique identifier of each user as a key. When detecting a missing value of data, the data management unit automatically complements a numerical value using a linear interpolation algorithm. The data management unit normalizes data including an outlier using a smoothing filter. The data management unit caches the data for which these preprocessings have been completed on a memory in a format that can be supplied to a subsequent artificial intelligence model. The data management unit dynamically reconstructs an index using a hash function every time data is updated. The data management unit executes this index reconstruction processing in a background parallel thread. Thereby, the system shortens a response time of a search query for an enormous amount of data to milliseconds. The system extremely streamlines an input data generation process to the artificial intelligence model. The system provides a technical improvement that optimizes a data structure itself inside a computer beyond mere digitization of data. As a specific application field of the system, a real-time patient state grasping system in a large-scale nursing care facility or hospital can be cited. The system realizes data management in a high-dimensional space, and establishes an unconventional data processing method different from a conventional method using only a relational database.

The generative AI processing unit automatically generates a personalized care plan, vital abnormality detection, mental care, a recreation proposal, a contact content to a family member or a medical worker, a communication content, a rehabilitation plan, medication management, an infectious disease countermeasure proposal, fall prevention advice, a night monitoring plan, an emergency response instruction, an accident prevention measure, meal content optimization, an excretion care proposal, a bedsore prevention measure, an oral care proposal, a swallowing function improvement program, a dementia progression suppression program, a sleep improvement proposal, a pain management proposal, a report for a family member, a record for submission to an administration, and the like for each user in real time based on the enormous amount of information stored in the data management unit, using the generative AI as an essential component. For example, when a body temperature is 37.8 degrees, a blood pressure is 150/90, and a pulse is 100 in a morning vital measurement, the generative AI automatically generates a specific response plan such as “Signs of fever, high blood pressure, and tachycardia. Contact a medical worker and instruct rest. Consider administration of an antipyretic or an antihypertensive drug as necessary. Increase water intake and strive to prevent dehydration. Consider isolation response because it is an infectious disease epidemic period.” For example, when a user C complains “I cannot sleep recently”, the generative AI analyzes a past sleep record, a medication status, a psychological state record, a nighttime activity amount, a noise level, and illuminance data, and automatically generates a care plan such as “Hold back on afternoon recreation today, and propose relaxing music appreciation after dinner. Consult a doctor as necessary and consider adjusting a sleep-inducing drug. Change nighttime lighting to a warm color system and eliminate a noise source.” For example, when a user D desires “I want to see my family”, the generative AI refers to a family contact, a past visiting history, family event information, and an infectious disease epidemic status, and performs cooperation support such as “Adjust a video call with the family in the near future. Automatically notify the family of the visiting request, and request wearing a mask during the visit for infectious disease countermeasures.” For example, for a user E with dementia, the generative AI proposes strengthening monitoring during a time zone with a high wandering risk, and immediately notifies a staff terminal of an alert of a wandering detection sensor. For example, for a user F with a high fall risk, the generative AI automatically generates walking training, lower limb muscle strength training, a timing proposal for toilet guidance, an inspection instruction for a floor material and a handrail, and the like. Specifically, the generative AI processing unit implements an ensemble architecture combining a large language model equipped with a self-attention mechanism and a recurrent neural network for time-series prediction. The generative AI processing unit inputs multidimensional data extracted from the data management unit to an artificial intelligence model. Input data to the artificial intelligence model includes a 768-dimensional embedding vector indicating a user profile, and a time-series tensor of 24 rows and 5 columns indicating vital data for the past 24 hours. For example, the input time-series tensor is composed of five features: body temperature, systolic blood pressure, diastolic blood pressure, pulse, and blood oxygen saturation. The artificial intelligence model combines these input data on a latent space, and performs feature extraction via a multilayer perceptron. Output data from the artificial intelligence model is a floating-point score in a range of 0.0 to 1.0 indicating an abnormality probability, a one-hot vector indicating a category of a corresponding action, and a text token sequence constituting a care plan. For example, the output abnormality probability score may be 0.85, and the category vector may indicate an emergency medical intervention. The generative AI processing unit determines whether or not the output abnormality probability score exceeds a preset threshold of 0.8. When the score exceeds the threshold, the generative AI processing unit immediately transfers the output data to an emergency alert generation module as subsequent processing. The generative AI processing unit decodes the text token sequence, and generates a specific response instruction character string in natural language. The artificial intelligence model is pre-trained using a past excellent care record as teacher data by a gradient descent method using a cross-entropy error function. The system replaces a conventional care plan creation work depending on human intuition and experience with a deterministic algorithm based on a high-dimensional tensor operation. Thereby, the system eliminates variation in personalized judgment, and exhibits a technical effect of homogenizing care quality. As a specific application field of the system, a clinical decision support system that supports decision making of a nursing care staff member can be cited. The system realizes an improvement of a computer technology that dynamically links an analysis result of numerical data and natural language generation, not limited to mere text generation.

The user interface unit provides various input means such as a touch panel, voice input, image input, a selective UI, a chatbot format, QR code reading, a barcode scan, face authentication, fingerprint authentication, and NFC cooperation so that a nursing care staff member or a user can intuitively operate from the terminal. For example, when a staff member inputs vital data, numerical input, a barcode scan, or voice input is possible, and when a user conveys a mood or a desire, input can be performed by voice or a simple choice. A care plan, advice, a recreation proposal, an abnormality detection notification, a contact content to a family member or a medical worker, and the like automatically generated by the generative AI are immediately presented by a screen or voice of the terminal, a notification message, print output, mail transmission, LINE cooperation, calendar cooperation, or the like. For example, it is also possible for a staff member to scan a QR code during a night patrol and automatically input a patrol record. Specifically, the user interface unit includes a dedicated hardware control module configured to integrally process a multimodal input stream. The user interface unit digitally samples an analog voice signal acquired from a microphone, and converts it into a two-dimensional acoustic feature tensor composed of a mel-frequency cepstral coefficient. The user interface unit inputs this acoustic feature tensor to a convolutional neural network-based voice recognition model. The voice recognition model outputs a probability distribution of phonemes from the input tensor, and extracts an optimal text character string using a Viterbi search algorithm. The user interface unit expands image data acquired from a camera on a memory as a three-dimensional image tensor having three channels of RGB. For example, the input image tensor has a dimension number of 224 pixel rows, 224 pixel columns, and 3 channels. The user interface unit inputs this image tensor to an edge detection algorithm and a feature point extraction algorithm, and specifies spatial coordinates of a QR code or a barcode. The user interface unit applies an affine transformation to the specified coordinate area, corrects distortion of an image, and then executes decoding processing. The user interface unit receives text data and an importance score output from the generative AI processing unit. The user interface unit dynamically changes a rendering parameter on a display screen based on the received importance score. For example, when the importance score is 0.9 or more, the user interface unit issues a rendering command to enlarge a font size of a text and set a background color to red. The user interface unit executes these drawing processings at high speed using a parallel operation pipeline of a graphics processing unit. Thereby, the system brings about a technical effect of physically reducing an input load of a user and reducing an occurrence probability of a human error. The system prevents an information transmission delay, and dramatically improves responsiveness of the system in an emergency. As a specific application field of the system, a hands-free input system in a nursing care field where hands tend to be occupied, or an alert display system requiring visual attention calling can be cited. The system improves a processing method inside a computer that efficiently controls a hardware resource, not a mere design of a screen display.

The learning accumulation unit sequentially receives feedback, a correction content, and an additional instruction from a user or a staff member, an irregular response case occurring in the field, an accident and near-miss record, a request from a family member, a guidance content from an administration, a handover from a medical worker, a handover content between staff members, a preference change of a user, a physical condition change for each season, a response history during an infectious disease epidemic, an evacuation response record during a disaster, and the like, and accumulates these as learning data. For example, when a staff member makes a correction such as “I want to change an afternoon activity of this care plan”, “I want to add a family interview to this advice”, “I want to replace this recreation proposal with another activity”, or “I want to correct this medication proposal because it is different from a doctor's instruction”, the learning accumulation unit records the content and utilizes it for optimization of a care plan and a proposal content from next time onward. For example, when a user feeds back “I do not like this communication content”, the generative AI learns the content, and thereafter automatically generates a dialogue content tailored to the user's preference. For example, even when there is a request from a family member such as “I want to change a desired visiting date” or “I want hobby activities of the user to be increased”, the learning accumulation unit records it and reflects it in a care plan from next time onward. Specifically, the learning accumulation unit constructs an online learning pipeline for performing continuous model updating during system operation. The learning accumulation unit extracts a difference between an initial proposal text output by the generative AI and a final text corrected by a staff member. The learning accumulation unit specifies an editing operation sequence between texts using a Levenshtein distance algorithm. The learning accumulation unit digitizes this editing operation sequence, and defines it as a reward signal in a reinforcement learning algorithm. For example, a scalar value indicating a higher reward value as a correction amount is smaller is calculated. The learning accumulation unit dynamically generates a learning data set in which the extracted difference data and context information are paired. The learning accumulation unit inputs this data set to a fine-tuning module of an artificial intelligence model. The fine-tuning module updates only a weight matrix of a part of intermediate layers of a neural network using a parameter efficiency method called low-rank adaptation. The learning accumulation unit manages a replay buffer memory holding a past representative learning sample. The learning accumulation unit mixes past data in the replay buffer at a certain ratio during learning with new data. Thereby, the system prevents a catastrophic forgetting phenomenon peculiar to a neural network. The learning accumulation unit iteratively fine-tunes a weight parameter so as to minimize a value of an error function using a gradient descent method. The system adopts an unconventional processing method that converts human feedback into a direct mathematical optimization process. Thereby, the system exhibits a technical effect of automatically acquiring facility-specific domain knowledge and an individual preference of a user as a parameter inside a model. The system significantly reduces a calculation cost and time required for re-learning, and improves utilization efficiency of a computer resource. As a specific application field of the system, a self-evolving business support system whose accuracy improves as operation continues can be cited. The system provides an improvement of a computer technology that autonomously improves inference accuracy of an artificial intelligence model, not mere accumulation of data.

The sensor cooperation unit collects vital data, behavior data, and environmental data in real time from a terminal, a nursing care robot, a wearable device, a bed sensor, a wandering detection sensor, a fall detection sensor, an environmental sensor (temperature, humidity, illuminance, noise, CO2 concentration, PM2.5 concentration, pollen information, and the like), a smart home appliance, a smart lock, a smart camera, a nurse call system, and the like, and provides them to the data management unit and the generative AI processing unit. For example, the sensor cooperation unit acquires a heart rate, the number of steps, and fall detection data from a wearable device, and immediately transmits an alert if there is an abnormality. For example, when getting out of bed at night is detected by a bed sensor, the sensor cooperation unit immediately notifies a staff terminal, and prompts a patrol for fall prevention. For example, when a room temperature becomes high, the sensor cooperation unit automatically generates a notification such as “Heatstroke risk exists. Temperature adjustment of air conditioner is recommended.” For example, when a nurse call is frequently pressed, the AI estimates anxiety or a physical condition change of a user, and proposes additional monitoring or medical consultation. Specifically, the sensor cooperation unit includes a sensor fusion module configured to integrally process a data stream asynchronously transmitted from various hardware devices. The sensor cooperation unit normalizes a sampling rate of raw data received from each sensor. The sensor cooperation unit applies a Kalman filter algorithm to remove high-frequency noise included in a sensor signal. The sensor cooperation unit mathematically estimates and complements a missing part of data caused by a loss of a communication packet using a spline interpolation method. The sensor cooperation unit synchronizes each preprocessed sensor data based on a time stamp. The sensor cooperation unit constructs the synchronized data on a memory as a multidimensional time-series array. For example, the sensor cooperation unit integrates 3-axis acceleration data sampled at 100 hertz and temperature data sampled at 1 hertz, and generates a two-dimensional tensor having a time axis and a feature axis. The sensor cooperation unit arranges a lightweight convolutional neural network model in an edge environment such as a wearable device side. An input to the edge model is an acceleration tensor for the latest 3 seconds. An output from the edge model is a probability score indicating a fall state. The sensor cooperation unit executes subsequent processing of transmitting detailed data to a central server only when the probability score output by the edge model exceeds a threshold. Thereby, the system brings about a technical effect of dramatically reducing consumption of a network bandwidth and optimizing a communication load. The system avoids a processing delay on a cloud side, and ensures real-time responsiveness to an emergency situation. As a specific application field of the system, a real-time monitoring system in a smart nursing care facility where a large number of IoT devices operate can be cited. The system realizes an advanced distributed processing architecture combining edge computing and sensor fusion, not mere data collection. The system provides an improvement of a computer technology that overcomes a hardware constraint by a software algorithm.

The external cooperation unit cooperates with an electronic medical record system of a medical institution, a contact application for a family member, a nursing care record system of an administration, a rehabilitation support system, a pharmacy system, a school lunch management system, a pick-up and drop-off management system, a disaster information system, a comprehensive community support center, a care manager system, and the like, and mutually exchanges necessary information. For example, when a medical worker updates a prescription content, the external cooperation unit immediately reflects it in the system, and utilizes it for a care plan and medication management. For example, when a family member inputs a visiting request, the external cooperation unit automatically adjusts it with a facility schedule, and notifies a user and a staff member. For example, when a guidance content from an administration or a new infectious disease countermeasure guideline is issued, the AI automatically reflects it in a care plan and a facility operation plan. Specifically, the external cooperation unit implements a dedicated API gateway module that mediates data exchange between heterogeneous systems. The external cooperation unit uses a secure RESTful API or gRPC protocol in communication with an external system. The external cooperation unit executes data format conversion processing of parsing data in an XML format or a unique binary format received from an external system into a JSON format standardized inside the system. The external cooperation unit analyzes data in an HL7 FHIR format, which is a medical data standard, and maps each data element to a corresponding column of an internal database. The external cooperation unit analyzes a free-description medical text acquired from an external system using a natural language processing model. The natural language processing model extracts a medical term in a text, and converts it into a standardized identifier vector such as an International Classification of Diseases code. The external cooperation unit executes a differential synchronization algorithm in order to maintain data synchronization between an external system and an internal database. The external cooperation unit calculates a hash value of each data record, and compares it with a hash value at the time of previous synchronization. The external cooperation unit extracts only a record having a mismatched hash value, and performs update processing. Thereby, the system eliminates waste of transmitting and receiving all data every time, and exhibits a technical effect of significantly reducing a transaction load of a database. The system absorbs orthographical variants and format differences by an algorithm, and ensures semantic interoperability between systems. As a specific application field of the system, an information infrastructure platform in a comprehensive community care system in which a plurality of medical and nursing care institutions cooperate can be cited. The system realizes processing efficiency improvement inside a computer using data structure conversion and a differential extraction algorithm, not a mere network connection. The system completely eliminates manual data transcription work by a human, and mathematically guarantees consistency and accuracy of data.

The analysis and prediction unit executes trend analysis and future risk prediction for each user, operation optimization of an entire facility, staff arrangement optimization, infectious disease epidemic prediction, fall risk prediction, dementia progression prediction, bedsore occurrence risk prediction, evacuation plan optimization during a disaster, recreation effect analysis, family satisfaction analysis, and the like based on a long-term care history, vital data, an accident and near-miss record, an infectious disease epidemic history, a physical condition change for each season, a staff shift history, a recreation participation history, a family interview history, and the like. For example, the AI proposes a preventive measure such as “Since a user G has a tendency to easily lose physical condition in winter in the past three years, strengthen water intake and room temperature management particularly this winter.” For example, during a period when an infectious disease is likely to be epidemic in an entire facility, the analysis and prediction unit automatically proposes “increase in number of times of hand disinfection, visiting restriction, and ventilation strengthening”. Specifically, the analysis and prediction unit constructs a prediction model combining an autoregressive neural network and a graph convolutional network that learn a pattern of long-term time-series data. The analysis and prediction unit extracts history data for past several years from the data management unit, and aggregates it as a monthly or weekly statistical vector. Input data to the prediction model is, for example, a matrix tensor of 36 rows and 50 columns composed of vital statistical values and environmental data for the past 36 months. The prediction model inputs this input tensor to a time-direction convolutional layer and a long short-term memory layer, and calculates a hidden state vector. Output data from the prediction model is a vector indicating an occurrence probability distribution of a specific event in a specific future time frame. For example, the output data is an output value of a softmax function indicating that a fall probability within one month from now is 0.75 and an infectious disease onset probability is 0.20. The analysis and prediction unit inputs the output probability distribution vector to a clustering algorithm. The analysis and prediction unit classifies users into a plurality of risk clusters using a K-means method. The analysis and prediction unit executes subsequent processing of extracting a preventive measure template having the highest similarity to a centroid vector of each cluster from a database. The system adopts an unconventional processing method that replaces an ambiguous prediction based on a human rule of thumb with a probabilistic operation model in a high-dimensional space. Thereby, the system brings about a technical effect of quantitatively visualizing a potential risk and optimizing a timing of a preventive intervention. The system optimizes resource arrangement of an entire facility in a data-driven manner, and achieves both reduction of an operation cost and improvement of safety. As a specific application field of the system, a medium-to long-term management plan formulation support system in a nursing care facility or a risk screening system for preventive medicine can be cited. The system provides an improvement of a computer technology that expresses a complex causal relationship as a weight of a neural network and mathematically infers a future state, not mere aggregation of data.

The security management unit strictly manages sensitive information such as user information, medical data, and family contact information, and implements multi-layered security countermeasures such as access authority management, data encryption, communication encryption, log management, unauthorized access detection, terminal authentication, operation history auditing, information leakage countermeasures, data backup in the event of a disaster, and cyber attack countermeasures. For example, the security management unit limits an accessible information range for each staff member to protect privacy of a user and a family member. For example, in the event of a disaster, the security management unit automatically transmits a data backup to a remote server to ensure business continuity. Specifically, the security management unit applies a strict authentication and authorization pipeline based on a zero-trust architecture to the entire system. The security management unit executes a process of verifying a digital signature of a JSON Web Token for all API requests. The security management unit collates an identifier of a request source with a role-based access control matrix, and determines presence or absence of an operation authority for a requested resource at high speed by a bit operation. The security management unit applies a block encryption process using an AES 256-bit algorithm to all data stored in a storage. The security management unit constructs an end-to-end encryption tunnel using a TLS 1.3 protocol for data on a communication path. The security management unit collects all operation logs generated in the system as a time-series sequence. The security management unit inputs this log sequence to an autoencoder-type anomaly detection artificial intelligence model. An input to the anomaly detection model is a multidimensional array obtained by vectorizing a user ID, an IP address, an access time, and an operation type. The anomaly detection model compresses an input vector into a low-dimensional latent space, and then attempts to reconstruct the input vector into an original vector. An output from the anomaly detection model is a scalar value indicating a reconstruction error between the input vector and a reconstructed vector. When the calculated reconstruction error exceeds a dynamically set threshold value, the security management unit detects the access as an anomaly of an unknown cyber attack or an internal crime. When detecting the anomaly, the security management unit executes a subsequent process of immediately forcibly disconnecting a corresponding session and transmitting an alert to an administrator. Thereby, the system exhibits a technical effect of autonomously blocking an advanced threat that cannot be prevented by a rule-based firewall by an algorithm. Specific application fields of the system include a medical information system requiring high confidentiality and a cloud-based integrated management platform. The system provides an improvement in computer technology that fundamentally improves robustness of the system by dynamic behavior analysis using machine learning, rather than simple password management.

As described above, in the embodiment of the present invention, all data in a nursing care field is centrally managed, and a care plan, advice, abnormality detection, mental care, a recreation proposal, cooperation support with a family member and a medical worker, a rehabilitation plan, medication management, infection countermeasures, fall prevention, accident prevention, meal/excretion/sleep/oral/swallowing/pain management, and the like optimized for each user are automatically generated in real time using generative AI, and feedback from the field is immediately learned and reflected, thereby simultaneously realizing business efficiency improvement, homogenization and sophistication of care quality, improvement of user satisfaction, reduction of staff burden, strengthening of cooperation with a family member and a medical worker, optimization of facility operation, improvement of disaster response capability, efficiency improvement of administrative response, and future risk prediction and preventive intervention. For example, even when a plurality of users generate abnormalities at the same time, the AI automatically determines a priority and notifies a staff member in descending order of urgency. For example, based on a long-term care history and feedback, trend analysis and future risk prediction for each user are also possible. For example, the present invention can be applied to a recreation plan and staff shift management of an entire facility, and contributes to operation efficiency improvement of the entire nursing care field. Specifically, the entire system is constructed as a microservice architecture in which each processing module cooperates via an asynchronous messaging queue. The system adopts a publish-subscribe model to loosen a degree of coupling between modules. The system activates an artificial intelligence model for triage determination when a plurality of alerts occur simultaneously and frequently. The triage determination model is constructed using a gradient boosting decision tree algorithm. Input data to the triage determination model is a feature vector indicating an abnormality probability score of each alert, an underlying disease risk value of a user, and a current staff allocation status. Output data from the triage determination model is a priority score represented by an integer value from 0 to 100. The system dynamically sorts an alert queue based on the output priority score, and executes a notification process in descending order of the score. Thereby, the system brings about a technical effect of preventing a processing deadlock at the time of high load and dramatically improving scalability and availability of the entire system. The system automatically allocates limited computer resources and human resources to the most critical task. Specific application fields of the system include an integrated facility management system requiring large-scale resource optimization and a smart healthcare platform involving an emergency response. The system provides an improvement in computer technology that solves an optimization problem under complex constraint conditions in real time, rather than simple computerization of business. The system completely automates a series of cycles from data input to inference and feedback learning, and establishes an autonomously evolving information processing infrastructure.

### (System Configuration)

The system according to the present embodiment includes a data management unit, a generative AI processing unit, a learning accumulation unit, a user interface unit, a sensor cooperation unit, an external cooperation unit, an analysis/prediction unit, a security management unit, and a communication unit. The data management unit centrally manages personal attribute data such as a basic profile, a care need level, a past medical history, allergies, medication information, a family structure, an emergency contact, hobbies and preferences, a life pattern, religious/cultural considerations, presence/absence of dementia, presence/absence of physical disability, a past hospital admission/discharge history, a fall history, an infectious disease morbidity history, and a vaccination history for each user, and further integrally manages vital/health data such as body temperature, blood pressure, pulse, SpO2, body weight, blood glucose level, respiratory rate, electrocardiogram data, sleep apnea detection, step count, activity amount, meal intake amount, excretion frequency, urination/defecation state, skin state, presence/absence of bedsore, pain scale, swallowing function evaluation, and oral care record, a care history such as a meal content, a rehabilitation record, a medication history, an excretion record, a sleep status, a recreation participation history, a psychological state record, a family interview record, a medical treatment record, an infection countermeasure record, an emergency response history, an accident/near-miss record, an outing/overnight stay record, and an in-facility movement history, a facility schedule such as a meal time, a bathing time, a rehabilitation time, a recreation time, a visiting time, a night monitoring schedule, a staff shift, a cleaning/disinfection schedule, and an equipment inspection schedule, weather information such as temperature, humidity, atmospheric pressure, precipitation, weather forecast, heatstroke warning information, and influenza epidemic information, communication items such as a doctor's instruction, a nurse's handover, a request from a family member, a visiting request, a medication change request, an emergency contact change, and family event information, and nursing care insurance information such as a certification category, a usage limit amount, a service usage history, care manager information, and a notification from an administration. For example, when a user A has a past medical history of hypertension and diabetes, has hobbies of coloring and music appreciation, has an eldest son and an eldest daughter as family members, and requires religious considerations, all of this information is recorded in the data management unit. For example, when a user B has dementia, has a wandering tendency, and has a plurality of past fall histories, a fall risk evaluation and data of a wandering detection sensor are also managed in chronological order. For example, when a user C develops a fever during an infectious disease epidemic period, a vaccination history and an infection countermeasure record are also immediately referred to. For example, when a family member of a user D submits a visiting request, family event information and a visiting history are also centrally managed. Specifically, each processing unit constituting the system realizes a data integration mechanism using a multimodal encoder that maps heterogeneous mixed data to a common latent space. The data management unit executes a normalization process on various input data formats. The data management unit applies Z-score normalization to continuous values such as vital data to convert them into a distribution with a mean of zero and a variance of one. The data management unit applies one-hot encoding to categorical variables such as gender and blood type to convert them into sparse binary vectors. The data management unit applies a pre-trained language model to text data to convert it into a dense continuous value vector. The data management unit combines these normalized vectors to generate a single high-dimensional feature vector. Thereby, the system makes it possible to handle data of different formats as a unified mathematical expression. The system exhibits a technical effect of enhancing stability of gradient calculation in a subsequent artificial intelligence model and significantly improving a convergence speed of learning. Specific application fields of the system include an integrated data lake system in which a wide variety of data sources are mixed, and an entity management system having complex attribute information. The system provides a technical improvement of implementing a data preprocessing pipeline optimized for a machine learning algorithm inside a computer, rather than simple construction of a database.

Based on a vast amount of information stored in the data management unit, the generative AI processing unit uses generative AI as an essential component to automatically generate a personalized care plan, vital abnormality detection, mental care, a recreation proposal, a contact content to a family member or a medical worker, a communication content, a rehabilitation plan, medication management, an infection countermeasure proposal, fall prevention advice, a night monitoring plan, an emergency response instruction, an accident prevention measure, meal content optimization, an excretion care proposal, a bedsore prevention measure, an oral care proposal, a swallowing function improvement program, a dementia progression suppression program, a sleep improvement proposal, a pain management proposal, a report for a family member, a record for administrative submission, and the like for each user in real time. For example, when a body temperature is 37.8 degrees, a blood pressure is 150/90, and a pulse is 100 in a morning vital measurement, the generative AI automatically generates a specific response plan such as “Signs of fever, hypertension, and tachycardia. Contact a medical worker and instruct rest. Consider administration of an antipyretic or an antihypertensive drug as necessary. Increase water intake and strive to prevent dehydration. Consider isolation response due to an infectious disease epidemic period.” For example, when a user E complains “I cannot sleep recently”, the generative AI analyzes a past sleep record, a medication status, a psychological state record, a nighttime activity amount, a noise level, and illuminance data, and automatically generates a care plan such as “Hold back afternoon recreation today, and propose relaxing music appreciation after dinner. Consult a doctor as necessary and consider adjusting a sleep-inducing drug. Change nighttime lighting to a warm color and eliminate a noise source.” For example, when a user F requests “I want to see my family”, the generative AI refers to a family contact, a past visiting history, family event information, and an infectious disease epidemic status, and performs cooperation support such as “Coordinate a video call with the family in the near future. Automatically notify the family of a visiting request, and request wearing a mask during a visit for infection countermeasures.” For example, for a dementia user G, the generative AI proposes strengthening monitoring during a time zone with a high wandering risk, and immediately notifies a staff terminal of an alert of a wandering detection sensor. For example, for a user H with a high fall risk, the generative AI automatically generates walking training, lower limb muscle strength training, a timing proposal for toilet guidance, an inspection instruction for a floor material and a handrail, and the like. Specific examples of a prompt sentence to be read by the generative AI include “Please generate an optimal care plan for today based on a user's name, age, gender, care need level, past medical history, vital data, past care history, hobbies and preferences, family structure, weather information, and facility schedule. Please include morning and afternoon activity contents, notes, and communication items to a family member and a medical worker”, “Please analyze today's vital data (body temperature, blood pressure, pulse, SpO2, body weight) and propose a response plan if there is an abnormality”, “Please generate a communication content for grasping a psychological state of a user”, “Please propose a recreation activity based on hobbies and preferences of a user and weather information”, and “Please propose a fall prevention measure based on a fall risk evaluation and a past fall history”. Specifically, the generative AI processing unit includes a dynamic template engine that automates prompt engineering. The generative AI processing unit dynamically maps structured data acquired from the data management unit to a placeholder in a prompt template. The generative AI processing unit uses a transformer-based large language model having billions of parameters as an inference engine. Input data to the language model is an integer array tokenized by a byte pair encoding algorithm. For example, input data is a one-dimensional array consisting of a maximum of 4096 token IDs. The language model calculates a dependency relationship between input tokens using a self-attention mechanism, and outputs a probability distribution of a token appearing next. The generative AI processing unit applies a temperature parameter to the output probability distribution, and determines a next token using a sampling algorithm. The generative AI processing unit autoregressively repeats this process to generate a final text character string. The generative AI processing unit executes syntax analysis on the generated text, and performs a filtering process by pattern matching with a prohibited vocabulary list as a subsequent process. Thereby, the system exhibits a technical effect of suppressing occurrence of hallucination not based on facts and mathematically ensuring safety of output text. Specific application fields of the system include an automatic document generation system requiring advanced expert knowledge and a context-dependent interactive agent system. The system provides an improvement in computer technology that dynamically synthesizes natural language after deeply understanding a context, rather than simple filling-in-the-blanks of a fixed phrase.

The learning accumulation unit sequentially receives feedback, a correction content, and an additional instruction from a user or a staff member, an irregular response case occurring in the field, an accident/near-miss record, a request from a family member, a guidance content from an administration, a handover from a medical worker, a handover content between staff members, a change in user preference, a seasonal physical condition change, a response history during an infectious disease epidemic, an evacuation response record during a disaster, and the like, and accumulates these as learning data. For example, when a staff member makes a correction such as “I want to change an afternoon activity of this care plan”, “I want to add a family interview to this advice”, “I want to replace this recreation proposal with another activity”, or “I want to correct this medication proposal because it differs from a doctor's instruction”, the learning accumulation unit records the content and utilizes it for optimization of a care plan and a proposal content from next time onward. For example, when a user feeds back “I do not like this communication content”, the generative AI learns the content, and thereafter automatically generates a dialogue content tailored to the user's preference. For example, even when there is a request from a family member such as “I want to change a desired visiting date” or “I want to increase hobby activities of a user”, the learning accumulation unit records the request and reflects it in a care plan from next time onward. For example, when a guidance content from an administration or a new infection countermeasure guideline is issued, the AI automatically reflects it in a care plan and a facility operation plan. Specifically, the learning accumulation unit implements an online learning algorithm for streaming data. The learning accumulation unit collects feedback data generated during system operation in real time, and dynamically configures a mini-batch for learning. The learning accumulation unit automatically adjusts a batch size according to availability of available computer resources. The learning accumulation unit calculates a gradient of a loss function for new data. The learning accumulation unit blends an existing weight parameter and a newly calculated gradient using an exponential moving average to update a weight of a model. The learning accumulation unit randomly extracts data from a replay buffer holding past important learning samples, mixes the data with new data, and causes learning. Thereby, the system effectively prevents a catastrophic forgetting phenomenon of forgetting an important pattern learned in the past while acquiring new knowledge. The system brings about a technical effect of dramatically reducing a calculation cost and power consumption as compared with batch learning in which an entire model is re-learned from scratch. The system immediately adapts the system to an environmental change or a new rule without downtime. Specific application fields of the system include a business support system in which rules frequently change during daily operation, and a recommendation system personalized according to user preferences. The system provides an improvement in computer technology that continuously and efficiently optimizes an internal state of an artificial intelligence model, rather than simple log storage.

The user interface unit provides various input means such as a touch panel, voice input, image input, a selective UI, a chatbot format, QR code reading, barcode scanning, face authentication, fingerprint authentication, and NFC cooperation so that a nursing care staff member or a user can intuitively operate from a terminal, and when a staff member inputs vital data, numerical input, barcode scanning, or voice input is possible, and when a user conveys a mood or a wish, input can be performed by voice or a simple option. A care plan, advice, a recreation proposal, an abnormality detection notification, a contact content to a family member or a medical worker, and the like automatically generated by the generative AI are immediately presented by a screen or voice of a terminal, a notification message, print output, email transmission, calendar cooperation, or the like. For example, a staff member can scan a QR code during a night patrol to automatically input a patrol record. For example, when a user conveys “I feel good today” by voice input, the AI immediately reflects the information in a care plan. Specifically, the user interface unit adopts an event-driven architecture that synchronizes multimodal input signals on a time axis. The user interface unit compares a time stamp of a voice stream with a time stamp of a tap event on a touch panel, and determines whether the input is based on the same operation intention. The user interface unit inputs synchronized multimodal data to a bidirectional long short-term memory network for intention estimation. Input data to the intention estimation model is a combined tensor of a voice feature vector and a touch coordinate vector. Output data from the intention estimation model is a vector indicating a probability distribution of a class to which a user's operation intention belongs. For example, output data is a numerical array indicating that a vital input intention is 0.9 and an emergency call intention is 0.05. The user interface unit executes a subsequent process of specifying an intention class with the highest probability and generating a corresponding system command. When a voice recognition result includes ambiguity, the user interface unit automatically corrects misrecognition using a context of touch input. Thereby, the system exhibits a technical effect of extracting a user's operation intention with extremely high accuracy even in a noisy field environment. The system prevents rework due to erroneous input and shortens a required time until task completion. Specific application fields of the system include a control interface of a smart home cooperating with an IoT device and a hands-free operation terminal in an industrial field. The system provides an improvement in computer technology that mathematically integrates a plurality of sensor inputs and decodes human intention by an algorithm, rather than simple contrivance of screen design.

The sensor cooperation unit collects vital data, behavior data, and environmental data in real time from a terminal, a nursing care robot, a wearable device, a bed sensor, a wandering detection sensor, a fall detection sensor, an environmental sensor (temperature, humidity, illuminance, noise, CO2 concentration, PM2.5 concentration, pollen information, and the like), a smart home appliance, a smart lock, a smart camera, a nurse call system, and the like, and provides the data to the data management unit and the generative AI processing unit. For example, the sensor cooperation unit acquires a heart rate, a step count, and fall detection data from a wearable device, and immediately transmits an alert if there is an abnormality. For example, when a bed sensor detects getting out of bed at night, the sensor cooperation unit immediately notifies a staff terminal and prompts a patrol for fall prevention. For example, when a room temperature becomes high, the sensor cooperation unit automatically generates a notification such as “Heatstroke risk exists. Temperature adjustment of air conditioner is recommended.” For example, when a nurse call is frequently pressed, the AI estimates anxiety or a physical condition change of a user, and proposes additional monitoring or medical consultation. Specifically, the sensor cooperation unit executes an advanced sensor fusion algorithm for integrally estimating a state in a space. The sensor cooperation unit inputs data acquired from a plurality of environmental sensors to an extended Kalman filter. The sensor cooperation unit sequentially estimates a state vector indicating a temperature distribution in a space or three-dimensional coordinates of a person using a variance-covariance matrix of observation noise of each sensor. The sensor cooperation unit inputs the estimated state vector to a multivariate outlier detection algorithm. The anomaly detection algorithm calculates how much a current state vector deviates from a normal data distribution using a Mahalanobis distance. Output data from the anomaly detection algorithm is a distance score of a scalar value indicating a degree of anomaly. For example, when an output Mahalanobis distance is a value exceeding a rejection region of a predetermined chi-square distribution, the sensor cooperation unit determines that an abnormality has occurred. When determining that an abnormality has occurred, the sensor cooperation unit executes a subsequent process of packaging a related sensor data stream, adding a high priority flag, and transmitting the packaged sensor data stream to the generative AI processing unit. Thereby, the system brings about a technical effect of mathematically eliminating a false alarm caused by a malfunction of a single sensor or temporary noise. By analyzing a correlation among a plurality of sensors, the system accurately captures a complex abnormal state that cannot be detected by an individual sensor. Specific application fields of the system include an equipment abnormality detection system in a factory and an environmental control system in a smart building. The system provides a technical improvement of executing advanced signal processing using a probabilistic statistical model inside a computer, rather than simple data transfer.

The external cooperation unit cooperates with an electronic medical record system of a medical institution, a contact application for a family member, a nursing care record system of an administration, a rehabilitation support system, a pharmacy system, a school lunch management system, a pick-up/drop-off management system, a disaster information system, a comprehensive community support center, a care manager system, and the like, and mutually exchanges necessary information. For example, when a medical worker updates a prescription content, the external cooperation unit immediately reflects the updated prescription content in the system and utilizes it for a care plan and medication management. For example, when a family member inputs a visiting request, the external cooperation unit automatically coordinates with a facility schedule and notifies a user and a staff member. For example, when a guidance content from an administration or a new infection countermeasure guideline is issued, the AI automatically reflects it in a care plan and a facility operation plan. Specifically, the external cooperation unit constructs a data conversion pipeline for ensuring interoperability between systems having different data schemas. The external cooperation unit expands an XML format payload received from an external system on a memory, and analyzes it as a DOM tree structure. The external cooperation unit reconstructs an extracted data element in accordance with a JSON schema of an internal system. The external cooperation unit uses a pre-trained word embedding model in order to absorb orthographical variants of medical terms included in text data. The word embedding model converts an input word into coordinates on a multidimensional vector space. The external cooperation unit searches a dictionary database for a standardized code closest to an input word vector by calculating a cosine similarity. For example, the external cooperation unit automatically maps a disease name input in various notations to a unified identifier such as an ICD-10 code. The external cooperation unit executes a subsequent process of publishing data for which a conversion process has been completed to a messaging queue and asynchronously distributing the data to each internal module. Thereby, the system exhibits a technical effect of automatically resolving a semantic mismatch between systems by an algorithm. The system eliminates manual data cleansing work by a human, and completely automates a data integration process. Specific application fields of the system include a supply chain data integration system among a plurality of companies and a cross-disciplinary data cooperation infrastructure in an administrative agency. The system provides a technical improvement of realizing advanced data normalization processing using natural language processing and vector operation inside a computer, rather than simple provision of a communication interface.

The analysis/prediction unit executes trend analysis and future risk prediction for each user, operation optimization of an entire facility, staff allocation optimization, infection epidemic prediction, fall risk prediction, dementia progression prediction, bedsore occurrence risk prediction, evacuation plan optimization during a disaster, recreation effect analysis, family satisfaction analysis, and the like based on a long-term care history, vital data, an accident/near-miss record, an infectious disease epidemic history, a seasonal physical condition change, a staff shift history, a recreation participation history, a family interview history, and the like. For example, the AI proposes a preventive measure such as “Since a user I has a tendency to easily get sick in winter over the past three years, strengthen water intake and room temperature management particularly this winter.” For example, during a period when an infectious disease is likely to be epidemic in an entire facility, the AI automatically proposes “increase in number of times of hand disinfection, visiting restriction, and ventilation strengthening”. Specifically, the analysis/prediction unit executes a hybrid machine learning pipeline integrating macro trend analysis and micro state transition prediction. The analysis/prediction unit applies a moving average filter to past vital data of a user to generate a trend vector from which short-term noise is removed. The analysis/prediction unit inputs this trend vector to a K-means clustering algorithm, and allocates a current health state of a user to any of a plurality of latent clusters. The analysis/prediction unit constructs a Markov chain model in order to model a state transition probability between respective clusters. Input data to the Markov chain model is a one-hot vector indicating a current state cluster. Output data from the Markov chain model is a matrix indicating a transition probability to each state cluster at a next time step. For example, output data is a numerical matrix indicating that a probability of transitioning from a current stable state to a deteriorated state after one month is 0.15. When a calculated transition probability exceeds a specific threshold value, the analysis/prediction unit executes a subsequent process of extracting a corresponding risk scenario and a preventive measure template from a database. Thereby, the system brings about a technical effect of eliminating intuitive prediction and realizing statistically supported risk quantification based on a vast amount of past data. The system provides an objective index for determining an operation policy of an entire facility in a data-driven manner. Specific application fields of the system include a customer credit risk transition prediction system in a financial institution and an equipment preventive maintenance system in a manufacturing industry. The system provides a technical improvement of executing mathematical inference of a future state using a probabilistic model inside a computer, rather than simple data visualization.

A security management unit strictly manages sensitive information such as user information, medical data, and family contact information, and implements multi-layered security countermeasures such as access authority management, data encryption, communication encryption, log management, unauthorized access detection, terminal authentication, operation history auditing, information leakage countermeasures, data backup in the event of a disaster, and cyber attack countermeasures. For example, an accessible information range is limited for each staff member to protect the privacy of the user and the family. For example, in the event of a disaster, a data backup is automatically transmitted to a remote server to ensure business continuity. Specifically, the security management unit constructs a zero-trust security model that does not depend on network boundary defense inside the system. The security management unit executes cryptographic verification of an authentication token included in a request header for all internal API calls. The security management unit verifies a signature of the token using a public key cryptosystem, and mathematically proves the presence or absence of falsification. The security management unit evaluates a logical expression using a user role, an IP address of an access source, and an access time as variables, and generates a dynamic access control matrix. The security management unit adds a message authentication code using a hash function to a data payload immediately before being written to a database. The security management unit collects packet header information of network traffic generated in the system, and inputs the packet header information to an unsupervised learning-based abnormality detection model. Input data to the abnormality detection model is a multidimensional feature vector consisting of a transmission source IP, a destination port, a packet size, and a communication frequency. The abnormality detection model calculates how isolated an input vector is from a set of normal communication patterns using an isolation forest algorithm. Output data from the abnormality detection model is an anomaly score indicating a degree of abnormality. When the anomaly score exceeds a threshold, the security management unit executes subsequent processing of automatically blocking communication from a corresponding IP address at a firewall level. Thereby, the system exhibits a technical effect of autonomously reducing an information leakage risk due to unknown malware or an internal crime by an algorithm. Specific application fields of the system include a transaction monitoring system of a financial institution and a confidential information management platform of a government agency. The system provides an improvement in computer technology that fundamentally improves defense capability of the system by dynamic traffic analysis using machine learning, rather than mere enhancement of password authentication.

A communication unit is responsible for data transmission and reception between a terminal and a server, and between the server and an external system, and safely and efficiently transmits various data such as a business task, a processing result, learning data, feedback information, and sensor data. The communication unit also includes functions such as automatic retransmission at the time of a network failure, data compression, encrypted communication, real-time synchronization, batch transmission, and priority control. For example, the communication unit has a mechanism for preferentially transmitting an important alert and an emergency contact even when a communication failure occurs at night or in the event of a disaster. Specifically, the communication unit executes an intelligent bandwidth control algorithm adapted to a dynamic state change of a network. The communication unit periodically transmits a test packet, and constantly monitors a round trip time and a packet loss rate. The communication unit dynamically adjusts a TCP window size using these network metrics as state variables. The communication unit automatically selects an optimal data compression algorithm in accordance with characteristics of a data payload to be transmitted. For example, the communication unit applies a Brotli algorithm to text data, and applies run-length encoding to image data to minimize a data size. The communication unit adds a QoS tag indicating importance of data to a header of each packet stored in a transmission queue. When detecting that a network bandwidth is tight, the communication unit activates a priority control module. The priority control module evaluates a value of the QoS tag, and rearranges a high-priority packet such as an emergency alert to the head of the queue. The communication unit temporarily caches low-priority log data and the like in a local storage, and executes subsequent processing of performing batch transmission after the network bandwidth is recovered. Thereby, the system brings about a technical effect of mathematically guaranteeing reachability of critical data even under a poor communication environment. The system efficiently utilizes a limited network bandwidth to the utmost limit, and minimizes a communication delay of the entire system. Specific application fields of the system include an information sharing system at a disaster site where a communication infrastructure is unstable, and a telematics system of a connected car using mobile communication. The system provides a technical improvement that realizes advanced packet scheduling based on feedback control of a network state inside a computer, rather than mere data transmission and reception.

As described above, the system according to the present embodiment centrally manages all data in a nursing care field, automatically generates a care plan, advice, abnormality detection, mental care, a recreation proposal, cooperation support with a family member and a medical worker, a rehabilitation plan, medication management, infection countermeasures, fall prevention, accident prevention, meal, excretion, sleep, oral cavity, swallowing, and pain management, and the like optimized for each user in real time using generative AI, and immediately learns and reflects feedback from the field, thereby simultaneously realizing business efficiency improvement, homogenization and sophistication of care quality, improvement of user satisfaction, reduction of staff burden, strengthening of cooperation with a family member and a medical worker, optimization of facility operation, improvement of disaster response capability, efficiency improvement of administrative response, and future risk prediction and preventive intervention. Specific examples of a prompt sentence to be read by the generative AI include “Please generate an optimal care plan for today based on a name, an age, a gender, a nursing care level, a past medical history, vital data, a past care history, hobbies and preferences, a family structure, weather information, and a facility schedule of a user. Please include activity contents in the morning and afternoon, notes, and contact items to a family member and a medical worker”, “Please analyze today's vital data (body temperature, blood pressure, pulse, SpO2, and body weight), and propose a response plan if there is an abnormality”, “Please generate a communication content for grasping a psychological state of the user”, “Please propose a recreation activity based on hobbies and preferences of the user and weather information”, and “Please propose a fall prevention measure based on a fall risk evaluation and a past fall history”. Specifically, the system dynamically controls an overall architecture using a container orchestration technology in a distributed computing environment. The system packages each processing module as an independent container image, and arranges the container image in a plurality of calculation nodes on a cluster. The system constantly monitors a CPU usage rate and memory consumption of the entire system, and automatically scales out the number of replicas of a module whose load has rapidly increased. The system executes processing of collecting input data into a certain batch size in an inference pipeline of an artificial intelligence model. The system transfers a batched input tensor to a parallel calculation cluster using a graphics processing unit. The parallel calculation cluster executes a large-scale matrix product-sum operation concurrently using thousands of cores. When an inference result is output, the system triggers an asynchronous callback function to immediately execute subsequent notification processing and database update processing. Thereby, the system exhibits a technical effect of maximizing throughput for a huge data processing request and simultaneously realizing high availability and fault tolerance of the system. The system eliminates a single point of failure, and continues a service without stopping even when a hardware failure occurs. Specific application fields of the system include a large-scale cloud service infrastructure having millions of users and a mission-critical financial transaction system. The system goes beyond a framework of a mere business application, and provides an improvement in computer technology itself making full use of dynamic allocation of computer resources and a parallel processing algorithm.

### (Implementation Steps)

Step 1: Registration and Update of User Information and Care History A nursing care staff member inputs a basic profile (name, age, gender, nursing care level, past medical history, allergy, medication information, family structure, emergency contact, hobbies and preferences, life pattern, religious and cultural consideration, presence or absence of dementia, presence or absence of physical disability, past hospitalization and discharge history, fall history, infectious disease history, vaccination history, and the like) for each user in detail using a user interface unit of a terminal, and further sequentially registers and updates daily vital data (body temperature, blood pressure, pulse, SpO2, body weight, blood glucose level, respiratory rate, electrocardiogram data, sleep apnea detection, number of steps, activity amount, and the like), a meal content, a rehabilitation record, a medication history, an excretion record, a sleep status, a recreation participation history, a psychological state record, a family interview record, a medical treatment record, an accident and near-miss record, and the like. Thereby, a data management unit centrally manages a huge amount and a wide variety of information for each user. Specifically, in this step, the system executes strict validation processing and vectorization processing on input raw data. When receiving numerical data transmitted from the terminal, the system executes rule-based processing of collating the numerical data with a predefined allowable range matrix. For example, when input body temperature data is out of a range of 34.0 degrees to 42.0 degrees, the system throws exception processing prompting re-input as an input error. When receiving free-description text data, the system inputs the text data to a pre-trained language model. Input data to the language model is an integer array obtained by tokenizing a text character string. Output data from the language model is an embedding vector consisting of a 512-dimensional floating-point array capturing semantic features of the text. The system combines the generated embedding vector and the verified numerical data to generate a single data record. The system executes a cryptographic hash function using a unique identifier of the user as an input, and calculates a hash value. The system executes subsequent processing of routing the data record to a specific shard of a distributed database based on the calculated hash value. Thereby, the system brings about a technical effect of evenly distributing a write load to the database to a plurality of nodes. The system mathematically guarantees data quality at an input stage, and dramatically improves speed and accuracy of subsequent search processing and inference processing by an artificial intelligence model. Specific application fields of the system include a data input interface of a large-scale electronic medical record system and a data cleansing pipeline in a customer management system. The system provides a technical improvement that executes advanced data structuring using hash-based sharding and natural language processing inside a computer, rather than a mere data storage operation.

Step 2: Real-time Data Acquisition by Sensor and External System Cooperation A sensor cooperation unit automatically acquires vital data, behavior data, and environmental data in real time from a wearable device, a bed sensor, a wandering detection sensor, a fall detection sensor, an environmental sensor, a smart home appliance, a nurse call system, and the like, and transmits the data to the data management unit. An external cooperation unit cooperates with an electronic medical record system of a medical institution, a family contact application, an administrative nursing care record system, a rehabilitation support system, a pharmacy system, and the like, and mutually exchanges necessary information. Specifically, the sensor cooperation unit receives raw data asynchronously transmitted from a plurality of hardware devices. The sensor cooperation unit normalizes the received raw data at a predetermined sampling rate. The sensor cooperation unit converts the normalized data into a multidimensional time-series tensor. The sensor cooperation unit applies a linear interpolation algorithm to a missing value. The sensor cooperation unit executes low-pass filter processing to remove a noise component. The external cooperation unit establishes a secure communication protocol with an external system. The external cooperation unit converts data in a heterogeneous format acquired from the external system into standardized structured data. The external cooperation unit extracts a key-value type feature amount from unstructured text using a natural language processing model. The system integrates these preprocessed data. The system expands the integrated data on a memory as a high-dimensional feature vector. A processing unit transfers the feature vector to a subsequent inference module. With this configuration, the system minimizes a delay in data acquisition. The system enables real-time situation grasping. The system completely eliminates a time lag and an input error due to manual input by a human. The system dramatically improves data processing efficiency of the entire computer system. This technology is applied to a rapid decision-making support system in a medical and nursing care field. The system brings about a technical effect of improving accuracy of abnormality detection.

Step 3: Automatic Generation of Care Plan and Advice (Utilization of Generative AI) A generative AI processing unit comprehensively analyzes user information, vital data, a care history, hobbies and preferences, a family structure, weather information, a facility schedule, external cooperation data, and the like stored in the data management unit, and automatically generates a personalized care plan, vital abnormality detection, mental care, a recreation proposal, a contact content to a family member or a medical worker, a communication content, a rehabilitation plan, medication management, an infection countermeasure proposal, fall prevention advice, and the like for each user in real time. Specific examples of a prompt sentence to be read by the generative AI include “Please generate an optimal care plan for today based on a name, an age, a gender, a nursing care level, a past medical history, vital data, a past care history, hobbies and preferences, a family structure, weather information, and a facility schedule of a user. Please include activity contents in the morning and afternoon, notes, and contact items to a family member and a medical worker”, “Please analyze today's vital data (body temperature, blood pressure, pulse, SpO2, and body weight), and propose a response plan if there is an abnormality”, “Please generate a communication content for grasping a psychological state of the user”, “Please propose a recreation activity based on hobbies and preferences of the user and weather information”, and “Please propose a fall prevention measure based on a fall risk evaluation and a past fall history”. Specifically, the generative AI processing unit includes a large language model provided with a self-attention mechanism. The generative AI processing unit converts an input prompt sentence into an integer token sequence by a tokenizer. The generative AI processing unit maps the token sequence to a high-dimensional embedding vector space. Input data to the generative AI processing unit is a concatenated vector of a text token sequence and numerical data. The number of dimensions of the input data is, for example, 4096 dimensions. As a specific example of the input data, there is a numerical vector indicating an age of the user. As a specific example of the input data, there is a time-series array indicating a past blood pressure transition. As a specific example of the input data, there is a one-hot vector of a categorical variable indicating weather information. The generative AI processing unit performs a parallel operation on these embedding vectors using a multi-layer transformer block. The generative AI processing unit calculates a dependency relationship between respective tokens. The generative AI processing unit generates a hidden state vector considering a context. The generative AI processing unit calculates a probability distribution of a token appearing next in an output layer. Output data from the generative AI processing unit is structured text data and a reliability score of each proposal. As a specific example of the output data, there is a specific action instruction text of a care plan. As a specific example of the output data, there is a floating-point number score from zero to one indicating an urgency level of abnormality detection. As a specific example of the output data, there is an identifier list of a recommended recreation. The system compares the output reliability score with a preset threshold. The system transfers data to a subsequent notification module only when the score exceeds the threshold. The system triggers regeneration processing of an alternative plan when the score is less than the threshold. With this configuration, the system realizes objective and highly accurate plan generation that does not depend on a human rule of thumb. The system simultaneously processes a huge number of variables. The system optimizes utilization efficiency of calculation resources. This technology is applied to an automatic planning system for individualized medicine and personalized care. The system exhibits a technical effect of homogenizing quality of care.

Step 4: Presentation of Business Result and Proposal Content and Acquisition of Field Feedback The user interface unit immediately presents the care plan, advice, recreation proposal, abnormality detection notification, contact content to a family member or a medical worker, and the like automatically generated by the generative AI processing unit to a nursing care staff member or the user by various means such as a screen of the terminal, voice, a notification message, print output, email transmission, and calendar cooperation. After confirming the content, the staff member or the user can input a correction, an additional instruction, and feedback. Specifically, the user interface unit receives structured data output from the generative AI processing unit. The user interface unit converts the received data into a rendering tree for display. The user interface unit dynamically changes a display priority in accordance with an urgency score. The user interface unit pop-up displays information with high urgency on the forefront of the screen. The user interface unit executes drawing processing using a visual warning color. The user interface unit inputs text data to a voice synthesis engine. The voice synthesis engine generates voice waveform data from the text. The user interface unit outputs the generated voice waveform data from a speaker. The system receives a feedback input from the staff member. The system analyzes input text or voice by a natural language processing module. The system classifies a feedback content into a positive evaluation and a negative evaluation. The system extracts a content of a correction instruction as a difference vector. The system associates the extracted difference vector with original output data. The system stores these pair data in a learning database. With this configuration, the system reduces an interaction delay between the user and the system. The system provides intuitive operability. The system automates a feedback loop. The system streamlines a continuous re-learning process of a model. This technology is applied to a field support terminal requiring dynamic information presentation. The system brings about a technical effect of preventing a human error.

Step 5: Learning Accumulation of Feedback and Correction Content and Next Optimization The learning accumulation unit sequentially receives feedback, a correction content, and an additional instruction from a staff member or a user, an irregular response case occurring in the field, an accident and near-miss record, a request from a family member, a guidance content from an administration, a message from a medical worker, a handover content between staff members, a preference change of the user, a physical condition change for each season, a response history during an infectious disease epidemic, an evacuation response record in the event of a disaster, and the like, and accumulates these as learning data. These are immediately reflected in optimization of a care plan and a proposal content from next time onward. Specifically, the learning accumulation unit stores the received various unstructured data in a vector database. The learning accumulation unit inputs text data to an embedding model. The embedding model converts the text into a high-dimensional dense vector. The learning accumulation unit indexes these dense vectors. The system periodically executes fine-tuning processing. The system utilizes the accumulated feedback data as teacher data. The system updates a weight parameter of a large language model by a gradient descent method. The system applies a reinforcement learning algorithm based on human evaluation. The system defines a reward function. The system gives a high reward to an output with few corrections by the staff member. The system calculates an error of each layer of a neural network using an error backpropagation method. The system executes optimization while dynamically adjusting a learning rate. The system adds a regularization term to a loss function to prevent catastrophic forgetting. The system samples past important learning data from a replay buffer. The system mixes old and new data to create a mini-batch. With this configuration, the system autonomously adapts to an environmental change and a state change of the user. The system continuously improves accuracy of inference. The system eliminates the need for a manual rule update operation. The system realizes automation of data management and optimization of calculation efficiency. This technology is applied to a self-evolving artificial intelligence system. The system exhibits a technical effect of preventing obsolescence of the system in long-term operation.

### (Specific Use Case)

For example, when the system of the present invention is used in a nursing care facility for elderly people requiring nursing care, a basic profile (age, gender, degree of nursing care required, past medical history, allergies, medication information, family structure, hobbies and preferences, life pattern, presence or absence of dementia, fall history, and the like) for each user is registered in the data management unit, and daily vital data (body temperature, blood pressure, pulse, SpO2, body weight, blood glucose level, sleep status, number of steps, activity amount, and the like), a meal content, a rehabilitation record, an excretion record, a recreation participation history, a psychological state record, a family interview record, an accident/near-miss record, and the like are sequentially input and accumulated. A sensor linkage unit acquires data in real time from a wearable device, a bed sensor, a fall detection sensor, an environmental sensor, and the like, and transmits the data to the data management unit. For example, when a body temperature of 37.8 degrees, a blood pressure of 150/90, and a pulse of 100 are input in a morning vital measurement, the generative AI processing unit automatically generates a specific response plan such as “Signs of fever, high blood pressure, and tachycardia. Contact a medical worker and instruct rest. Consider administration of an antipyretic or an antihypertensive drug as necessary. Increase water intake and strive to prevent dehydration. Consider isolation response due to an infectious disease epidemic period,” and immediately presents the response plan to a staff member via the user interface unit. Specifically, the system holds the input vital data in a memory as a time-series tensor. The system operates an abnormality detection model using a recurrent neural network. Input data to the abnormality detection model is a time-series array of vital data for the past 24 hours. The number of dimensions of the input data is, for example, 144 steps of five-dimensional time-series data. As a specific example of the input data, there is heart rate variability data per minute. As a specific example of the input data, there is an array of continuous body temperature measurement values. The abnormality detection model calculates a hidden state vector from the input data. The abnormality detection model outputs a degree of deviation from a normal pattern as an abnormality score. Output data from the abnormality detection model is an abnormality score in a range from zero to one. As a specific example of the output data, there is a numerical value of a score of 0.85. The system determines that the abnormality score has exceeded a preset threshold. The system activates the generative AI processing unit using this determination result as a trigger. The generative AI processing unit generates a prompt in which the abnormality detection result and the basic profile of the user are combined. The generative AI processing unit generates text data of the response plan. The system transfers the generated response plan to a subsequent communication module. The communication module transmits a push notification to a terminal of the medical worker. With this configuration, the system exceeds the limit of visual monitoring by humans. The system captures a minute vital change in real time. The system prevents serious health damage. The present technology is applied to an advanced healthcare monitoring system. The system brings about technical effects of speeding up abnormality detection and optimizing a response.

In addition, when the user complains that “I cannot sleep recently”, the generative AI processing unit analyzes a past sleep record, a medication status, a psychological state record, a nighttime activity amount, a noise level, and illuminance data, and automatically generates a care plan such as “Refrain from afternoon recreation today, and propose relaxing music appreciation after dinner. Consult a doctor as necessary and consider adjusting a sleep-inducing drug. Change nighttime lighting to a warm color system and eliminate a noise source.” Furthermore, when the user desires to “see my family”, the generative AI processing unit refers to family contact information, a past visitation history, family event information, and an infectious disease epidemic status, and performs cooperation support such as “Coordinate a video call with the family in the near future. Automatically notify the family of the visitation request, and request wearing a mask during the visitation for infectious disease countermeasures.” Specifically, the system acquires an utterance voice of the user from a microphone. The system converts voice waveform data into text data using a voice recognition engine. The system extracts an intent vector from the text data using a natural language processing model. The system combines the intent vector and a numerical vector of illuminance and noise acquired from the environmental sensor. The system inputs the combined multimodal feature vector to the generative AI processing unit. Input data to the generative AI processing unit is a concatenated tensor of an embedding vector of text and a normalized numerical vector of environmental data. As a specific example of the input data, there is a text vector indicating a complaint of a sleep disorder. As a specific example of the input data, there is an array of decibel values indicating an average nighttime noise level. The generative AI processing unit dynamically weights the importance of each input feature amount using an attention mechanism. The generative AI processing unit outputs a candidate for a solution as a probability distribution. Output data from the generative AI processing unit is structured JSON data including a specific action plan. As a specific example of the output data, there is a data object including a lighting control command. As a specific example of the output data, there is a data object including a schedule change instruction. The system parses the output structured data. The system transmits the lighting control command to a subsequent IoT control module. The IoT control module automatically changes a color temperature of smart lighting in a living room. The system transmits the schedule change instruction to a calendar management module. With this configuration, the system integrally processes a plurality of heterogeneous data. The system executes more multifaceted data analysis while imitating a human reasoning process. The present technology is applied to an advanced life support system linked with smart home technology. The system exhibits technical effects of automating environmental control and improving the quality of care.

Furthermore, for a user with dementia, the system proposes strengthening monitoring during a time zone with a high wandering risk, and immediately notifies a staff terminal of an alert from a wandering detection sensor. For a user with a high fall risk, the system automatically generates walking training, lower limb muscle strength training, a timing proposal for toilet guidance, an inspection instruction for a floor material and a handrail, and the like. Regarding recreation activities, the system makes a proposal such as “Propose a walk in the courtyard in the morning because it is fine weather today, and recommend coloring and music appreciation in the afternoon” based on the hobbies and preferences of the user, weather information, a facility schedule, and a past participation history. Specifically, the system operates a behavior prediction model using a convolutional neural network. Input data to the behavior prediction model is a continuous image tensor and spatial coordinate data from a camera installed in the facility. The number of dimensions of the input data is, for example, 30 frames of an image of 256 pixels vertically and horizontally and three channels. As a specific example of the input data, there is a coordinate array indicating a walking trajectory of the user. As a specific example of the input data, there is a vector of a periodic function indicating a time zone. The behavior prediction model extracts a spatial feature map from the image tensor. The behavior prediction model calculates a future behavior probability by time-series recursive processing. Output data from the behavior prediction model is an array of prediction probabilities for each behavior category. As a specific example of the output data, there is a numerical value indicating that the probability of wandering behavior is 90 percent. As a specific example of the output data, there is a floating-point number indicating a fall risk score. The system executes branch processing when the prediction probability exceeds a set threshold. When determining that the wandering risk is high, the system transmits a lock command to a subsequent electronic lock control module. When determining that the fall risk is high, the system transmits a prompt for generating a preventive measure to the generative AI processing unit. The generative AI processing unit searches a past success case database. The generative AI processing unit generates an optimal preventive measure text. With this configuration, the system enables predictive intervention instead of a reactive response. The system processes high-dimensional image data and time-series data in real time. The system complements the limit of human monitoring capability. The present technology is applied to an advanced monitoring system using computer vision. The system brings about technical effects of preventing accidents and reducing the business load on staff.

Feedback, a correction content, and an additional instruction from a staff member or a user, an irregular response case occurring on site, an accident/near-miss record, a request from a family member, a guidance content from an administration, a message from a medical worker, a handover content between staff members, a change in user preference, a seasonal physical condition change, a response history during an infectious disease epidemic, an evacuation response record during a disaster, and the like are sequentially recorded in the learning accumulation unit, and are utilized for optimization of a care plan and a proposal content from next time onward. Specifically, the system adopts a continuous learning architecture. The system performs morphological analysis on various input record data by natural language processing. The system extracts an important keyword and maps it to a feature vector space. The system classifies these feature vectors by a clustering algorithm. The system detects a case where a new case vector is separated from an existing cluster by a certain distance or more as an unknown pattern. The system registers the unknown pattern in a queue as learning data with high priority. The system executes a background learning process on a parallel computing cluster using a GPU. The system calculates a cross-entropy error as a loss function. The system minutely updates a weight matrix of a neural network using an optimization algorithm. The system transfers knowledge of a large-scale model to a lightweight inference model using knowledge distillation technology. The system distributes the updated inference model to a local processing unit on an edge device. With this configuration, the system reduces a communication load on a central server. The system improves an inference speed on an edge side. The system dynamically adapts the model to a daily changing on-site situation. The system processes a complex event that cannot be handled by a static rule-based system. The present technology is applied to an adaptive AI system in a distributed computing environment. The system exhibits a technical effect of preventing accuracy degradation of the model and always maintaining the latest inference capability.

Specific examples of a prompt sentence to be read by the generative AI include “Please generate an optimal care plan for today based on the name, age, gender, degree of nursing care required, past medical history, vital data, past care history, hobbies and preferences, family structure, weather information, and facility schedule of the user. Please also include morning and afternoon activity contents, notes, and contact items to a family member and a medical worker,” “Please analyze today's vital data (body temperature, blood pressure, pulse, SpO2, body weight) and propose a response plan if there is an abnormality,” “Please generate a communication content for grasping the psychological state of the user,” “Please propose a recreation activity based on the hobbies and preferences of the user and weather information,” and “Please propose a fall preventive measure based on a fall risk evaluation and a past fall history.” Specifically, the system includes a prompt engineering module. The prompt engineering module dynamically embeds structured data acquired from a database into a natural language template. The system divides the generated prompt character string into subword tokens by a byte pair encoding algorithm. The system converts each token into a multidimensional embedding vector. The system adds a positional encoding vector to hold order information of the tokens. Input data to the system is a huge tensor in which these vectors are concatenated. The number of dimensions of the input data depends on a context window size of the model. As a specific example of the input data, there is an array of numerical tokens including the vital data of the user. As a specific example of the input data, there is an array of text tokens indicating a past care history. The system executes a matrix product operation in a high-dimensional space using a self-attention mechanism of a transformer architecture. The system scores relevance between the respective tokens. Output data from the system is a probability distribution vector having dimensions corresponding to a vocabulary size. As a specific example of the output data, there is an array of floating-point numbers indicating a probability of a word appearing next. As a specific example of the output data, there is a probability of a special token indicating completion of generation. The system decodes a token sequence with the highest probability using a beam search algorithm. The system inputs the decoded text to a subsequent parser module. The parser module extracts structured data in a JSON format from the text. With this configuration, the system achieves both generation of unstructured text and extraction of structured data. The system facilitates subsequent system linkage. The present technology is applied to an automatic inference and control system using a large language model. The system brings about a technical effect of dramatically improving processing efficiency of a task involving complex conditional branching.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL:https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### SECOND EMBODIMENT

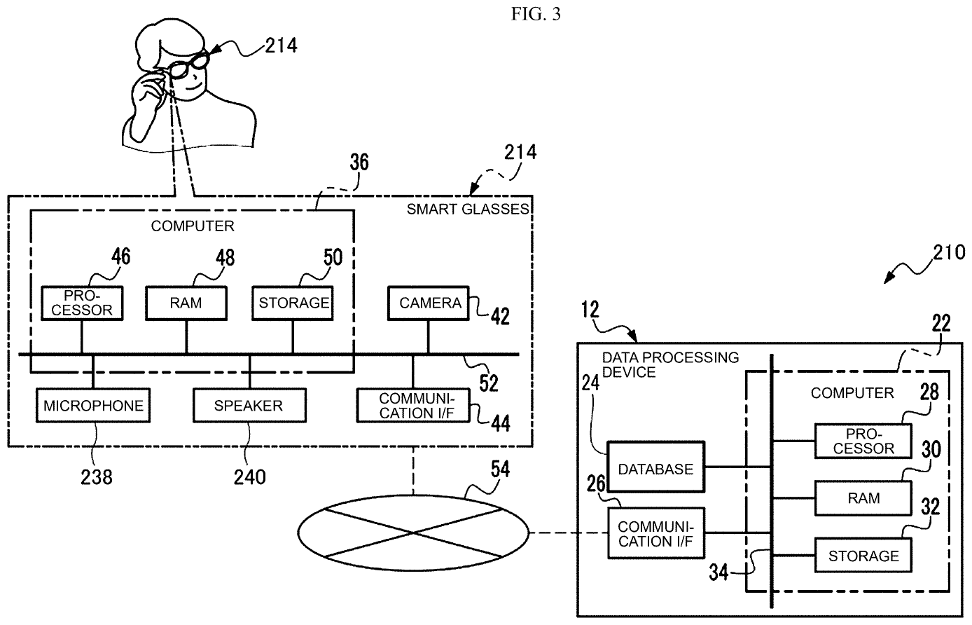

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

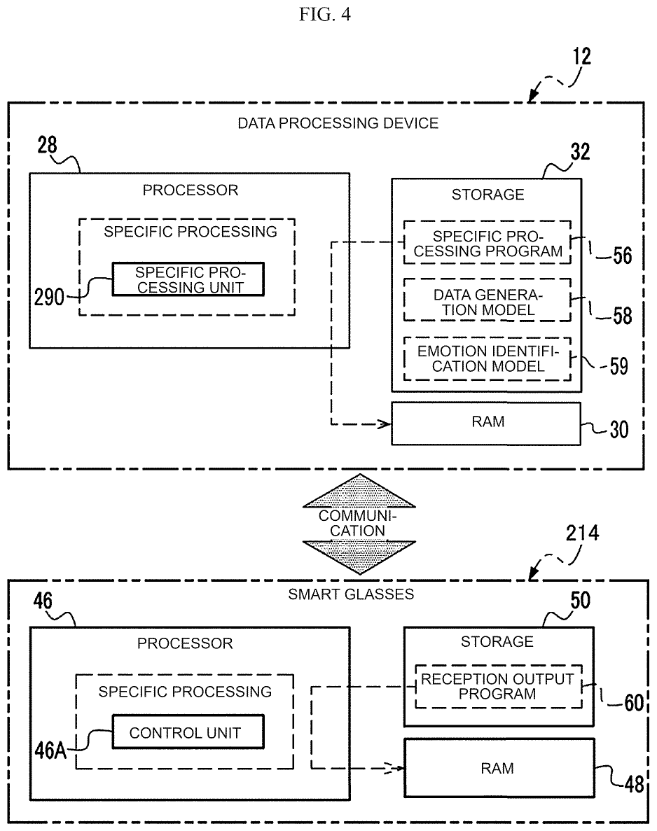

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### THIRD EMBODIMENT

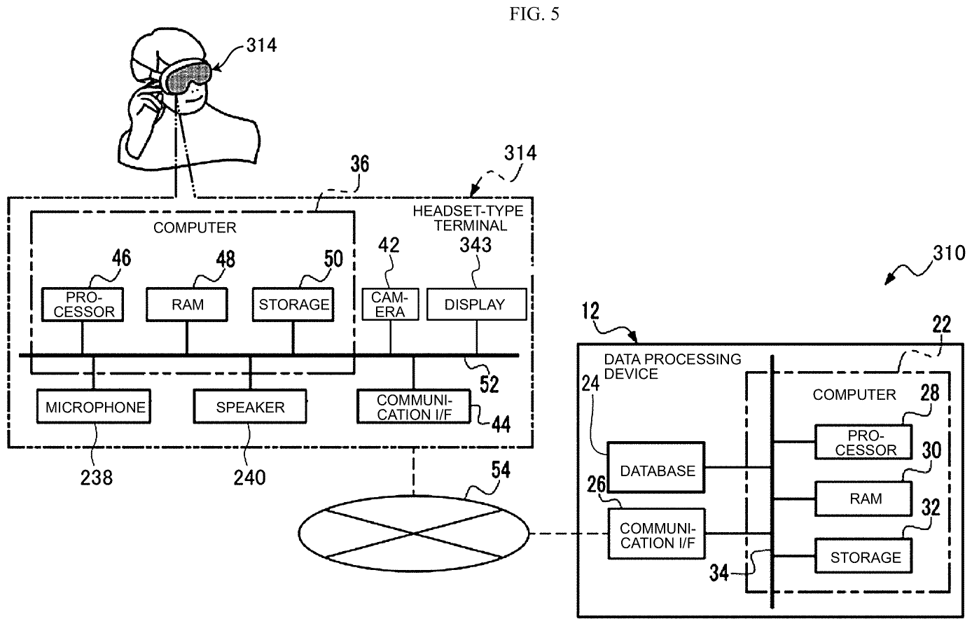

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

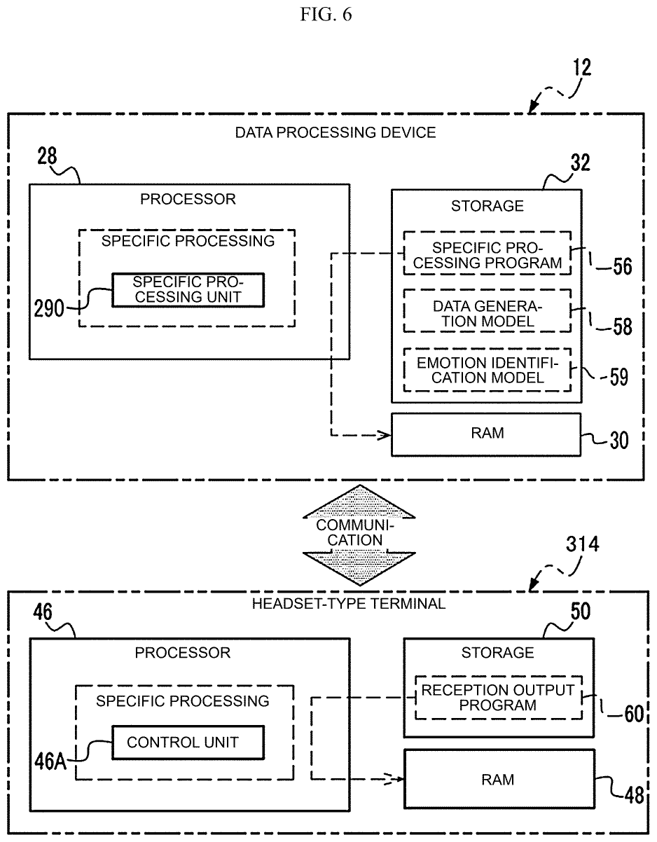

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### FOURTH EMBODIMENT

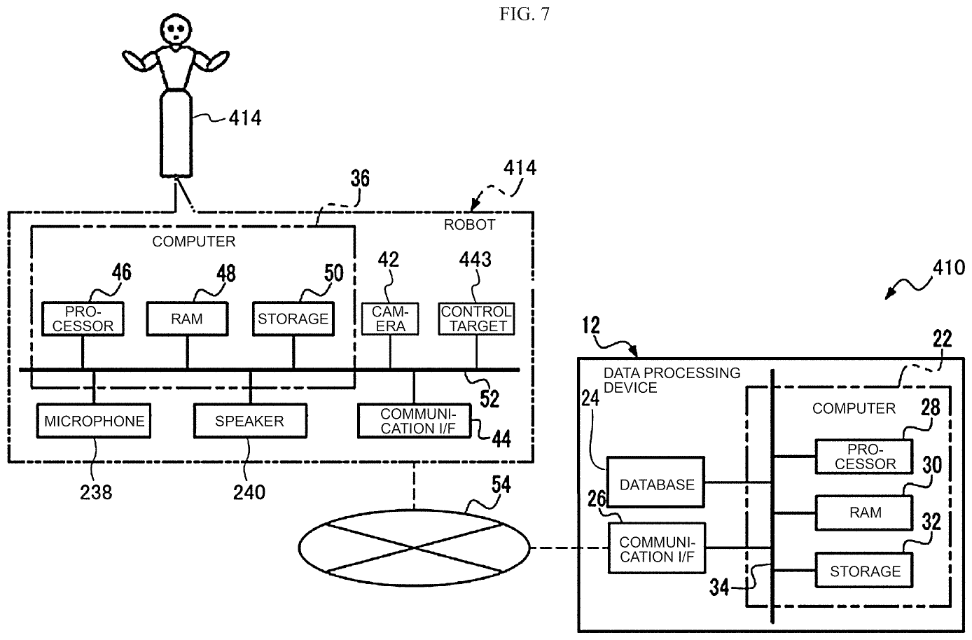

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

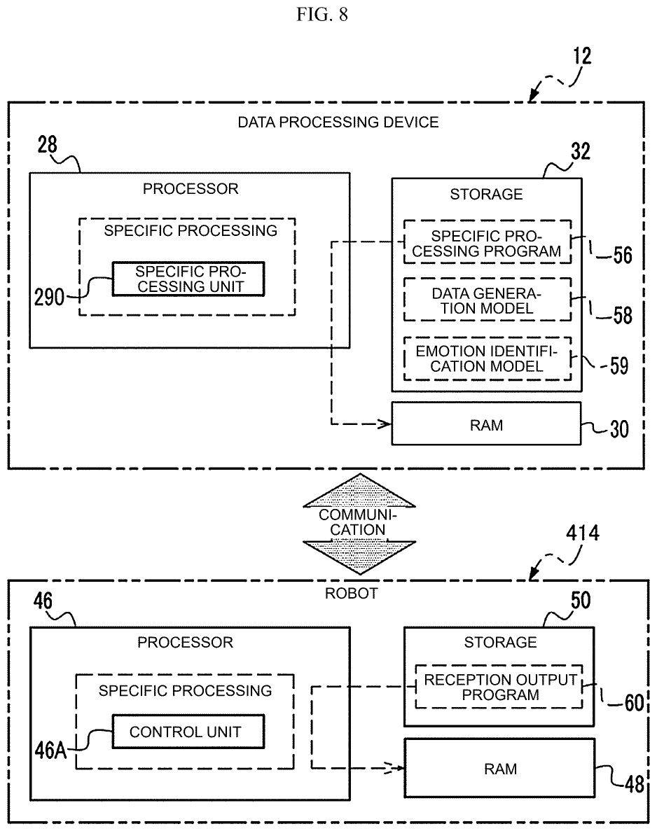

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

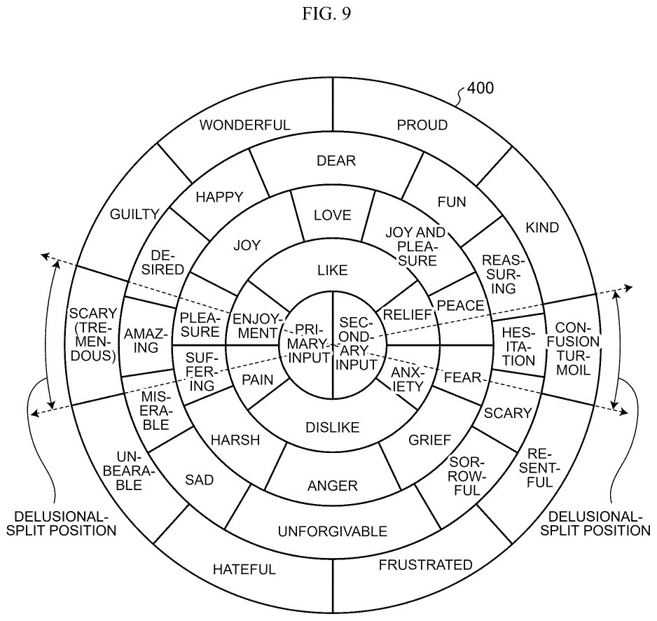

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

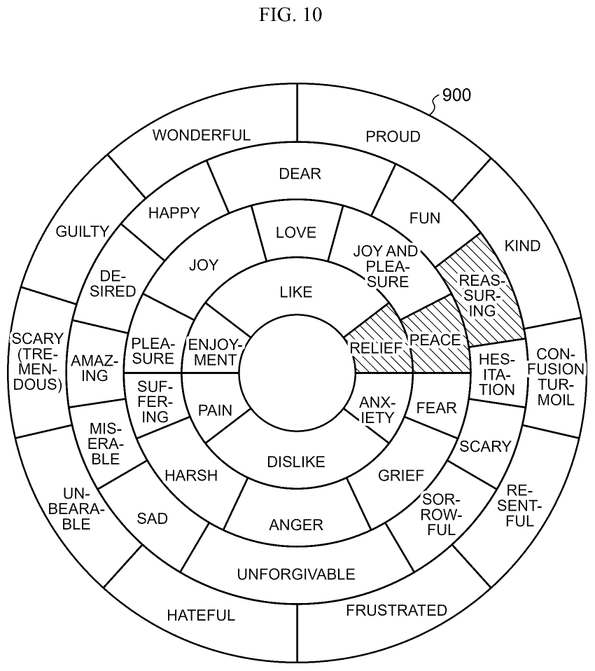

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system comprising: a data management unit configured to centrally manage a wide variety of nursing care-related data such as a basic profile, a family structure, hobbies and preferences, a past care history, vital data, medication information, a rehabilitation record, a meal content, and a sleep status for each user; a generative AI processing unit configured to comprehensively analyze various elements such as a health condition, a life pattern, hobbies and preferences, a past care history, vital data, a family structure, weather information, and a facility schedule of the user based on the information stored in the data management unit, using generative AI as an essential component, and automatically generate a personalized care plan, vital abnormality detection, mental care, a recreation proposal, a contact content to a family member or a medical worker, a communication content, and the like for each user in real time; and a learning accumulation unit configured to present the care plan, advice, communication content, recreation proposal, abnormality detection notification, contact content to a family member or a medical worker, and the like generated by the generative AI processing unit to a nursing care staff member or the user via a user interface unit of a terminal, further sequentially receive feedback, a correction content, and an additional instruction from the user or the staff member, accumulate these as learning data, and utilize the learning data for optimization of a care plan and a proposal content from next time onward, wherein the data management unit, the generative AI processing unit, and the learning accumulation unit cooperate to realize business efficiency improvement in a nursing care field, optimal care for each user, mental support, and strengthening of cooperation with a family member and a medical worker.

### Supplementary Note 2

The system according to Supplementary Note 1, wherein the generative AI processing unit is configured to analyze vital data (body temperature, blood pressure, pulse, SpO2, body weight, and the like) of the user in real time, immediately and automatically generate a specific response plan according to a situation, such as automatic contact to a medical worker, a rest instruction, a medication proposal, and a family notification in an emergency, when an abnormal value is detected, and further record a response history thereof in the learning accumulation unit so that an optimal response can be promptly proposed at the time of abnormality detection from next time onward.

### Supplementary Note 3

The system according to Supplementary Note 1, wherein the generative AI processing unit is configured to comprehensively analyze hobbies and preferences, weather information, a facility schedule, a past recreation history, a psychological state, and the like of the user, automatically generate a recreation activity and a communication content for enhancing satisfaction and psychological stability of the user, further record feedback from the user or a staff member in the learning accumulation unit, and reflect the feedback in a proposal content from next time onward, thereby continuously realizing mental care and recreation support optimized for each user.

What is claimed is:

1. A system comprising:
circuitry configured to:
receive, via a communication interface coupled to a packet-switched network, task specification data from a terminal device comprising a task type identifier and task content data, and store the task specification data in a storage device;
apply an agent selection model to the task type identifier to select a specialized processing agent from a plurality of pre-trained agent models stored in the storage device, each pre-trained agent model associated with a domain classification identifier and a knowledge base comprising domain-specific training data;
apply the selected specialized processing agent to the task content data to generate a task processing result, the selected specialized processing agent applying a generative neural network model to the task content data and domain-specific knowledge base records to produce the task processing result;
apply a continual learning update procedure to the selected specialized processing agent by extracting new training examples from the task content data and corresponding validated task processing results, and updating the knowledge base with new domain-specific records; and
transmit the task processing result to the terminal device via the communication interface, and store updated knowledge base records in the storage device for utilization in subsequent task processing sessions.

2. The system according to claim 1, wherein the circuitry is configured to receive analog sensor data from sensor devices connected to the terminal device via the communication interface, apply an analog-to-digital converter to generate digital data, apply a noise removal filter at an edge computing node on the terminal device, and transmit compressed feature vectors to the cloud computing node via the communication interface for incorporation into the task content data.

3. The system according to claim 2, wherein the circuitry is configured to apply a modality-specific encoder to each data type within the task content data comprising text data, numerical sensor arrays, image tensor data, and audio waveform data, and integrate encoded feature vectors from each modality encoder in a coupling layer to generate a multimodal input representation for the selected specialized processing agent.

4. The system according to claim 1, wherein the circuitry is configured to apply a task decomposition model to the task content data when the task type identifier indicates a multi-step task, generate a sub-task sequence comprising ordered sub-task identifiers and dependency constraints, and apply the selected specialized processing agent sequentially to each sub-task in the sub-task sequence.

5. The system according to claim 4, wherein the circuitry is configured to monitor the completion status of each sub-task in the sub-task sequence, detect a sub-task dependency constraint violation when a prerequisite sub-task has not reached a completed status, and suspend processing of the dependent sub-task until the prerequisite sub-task reaches completed status.

6. The system according to claim 1, wherein the circuitry is configured to retrieve knowledge base records relevant to the task content data by computing cosine similarity scores between a query embedding vector derived from the task content data and stored knowledge base record embedding vectors, and incorporate the top-ranked retrieved knowledge base records into a retrieval-augmented generation prompt for the selected specialized processing agent.

7. The system according to claim 6, wherein the circuitry is configured to update knowledge base record embedding vectors in a vector database when new domain-specific records are added to the knowledge base, and recompute approximate nearest neighbor indexing over the updated vector database to maintain retrieval accuracy.

8. The system according to claim 1, wherein the circuitry is configured to receive user interaction data from the terminal device via the communication interface during task processing comprising feedback ratings and correction inputs, incorporate the user interaction data as labeled training examples in the continual learning update procedure, and fine-tune the selected specialized processing agent on the labeled training examples.

9. The system according to claim 8, wherein the circuitry is configured to store user interaction data associated with a user identifier in the storage device, apply the selected specialized processing agent to the stored user interaction data to extract user-specific preference patterns, and personalize subsequent task processing results by conditioning the generative neural network model on the extracted user-specific preference patterns.

10. The system according to claim 1, wherein the circuitry is configured to maintain knowledge base records in the storage device beyond the end of a task processing session when a data retention parameter associated with the user identifier is set to a persistent storage value, and make the retained knowledge base records available for retrieval in subsequent task processing sessions associated with the same user identifier.

11. The system according to claim 1, wherein the circuitry is configured to apply a quality evaluation model to each generated task processing result by computing a factual grounding score measuring alignment between the task processing result and retrieved knowledge base records, and flag task processing results having factual grounding scores below a quality threshold for human review.

12. The system according to claim 1, wherein the circuitry is configured to apply the agent selection model to a composite feature vector derived from the task type identifier and task content data embedding to compute selection scores for each pre-trained agent model, and select the pre-trained agent model having the highest selection score.

13. The system according to claim 12, wherein the circuitry is configured to apply an ensemble processing procedure when the top two agent selection scores differ by less than a selection confidence threshold, generating a candidate task processing result from each of the two highest-scoring pre-trained agent models and applying a consensus scoring model to select or merge the candidate results.

14. The system according to claim 1, wherein the circuitry is configured to encrypt task content data and task processing results in transit using a transport layer security protocol, and enforce a data access control policy restricting access to stored knowledge base records to terminal devices associated with authorized user identifiers.

15. The system according to claim 1, wherein the circuitry is configured to deploy each pre-trained agent model as an independent containerized microservice, allocate graphics processing unit resources to high-compute inference requests, and distribute task processing requests across a plurality of agent model instances via a load balancer.

16. The system according to claim 1, wherein the circuitry is configured to store all task specification data, task processing results, user interaction data, and knowledge base update records in an audit log data structure with timestamps and user identifiers, and generate a knowledge base growth report from the audit log data structure.

17. The system according to claim 1, wherein the plurality of pre-trained agent models each comprise a generative neural network model fine-tuned on domain-specific training data, the knowledge base comprises domain-specific reference records and accumulated task processing examples, and the continual learning update procedure adds new task processing examples to the knowledge base without overwriting existing domain-specific training data.

18. A system comprising:
circuitry configured to:
receive, via a communication interface coupled to a packet-switched network, task specification data comprising a task type identifier and task content data from a terminal device;
apply an agent selection model to select a specialized processing agent from a plurality of pre-trained agent models each associated with a domain classification identifier and a knowledge base;
apply the selected specialized processing agent to the task content data, incorporating knowledge base records retrieved by cosine similarity search, to generate a task processing result;
apply a continual learning update procedure to update the knowledge base with new domain-specific records from the task content data and validated task processing results; and
transmit the task processing result and store updated knowledge base records for utilization in subsequent task processing sessions.

19. The system according to claim 18, wherein the circuitry is configured to apply a task decomposition model to generate sub-task sequences for multi-step tasks, monitor sub-task completion status and dependency constraints, and apply a quality evaluation model to compute factual grounding scores for each task processing result, flagging results below a quality threshold for human review.

20. A method comprising:
receiving, via a communication interface coupled to a packet-switched network, task specification data from a terminal device comprising a task type identifier and task content data, and storing the task specification data in a storage device;
applying an agent selection model to the task type identifier to select a specialized processing agent from a plurality of pre-trained agent models each associated with a domain classification identifier and a knowledge base;
applying the selected specialized processing agent to the task content data to generate a task processing result using a generative neural network model and domain-specific knowledge base records retrieved by cosine similarity search;
applying a continual learning update procedure to update the knowledge base with new domain-specific records from the task content data and corresponding validated task processing results; and
transmitting the task processing result to the terminal device via the communication interface, and storing updated knowledge base records in the storage device.
